(19) United States
(12) Patent Application Publication
(10) Pub. No.: US 2026/0073140 A1
(43) Pub. Date: Mar. 12, 2026

(54) UTILIZING DIGITAL PAGE SEQUENCE TOKENS WITH LARGE LANGUAGE MODELS TO GENERATE DIGITAL CONTENT PREDICTIONS

(71) Applicant: Adobe Inc., San Jose, CA (US)

(72) Inventors: Harshita Chopra, New Delhi (IN); Atanu R Sinha, Bangalore (IN); Saurabh Mahapatra, Sunnyvale, CA (US)

(21) Appl. No.: 18/829,774

(22) Filed: Sep. 10, 2024

(51) Int. Cl. G06F 40/284

(52) U.S. Cl. CPC G06F 40/284

(57) ABSTRACT

This disclosure describes one or more implementations of systems, non-transitory computer-readable media, and methods that utilizes digital page sequence data with large language models (LLMs) to generate digital page navigation predictions for users. In some implementations, the disclosed systems leverage large language models with page sequence input prompts to predict page sequences in additional digital navigation sessions. Indeed, in one or more implementations, the disclosed systems tokenize page sequences from user navigation data and utilize the tokenized page sequences to generate input prompts to utilize with an LLM to generate page sequence predictions. Furthermore, in some instances, the disclosed systems train an LLM to predict page sequences using a page order agnostic loss. Indeed, in one or more implementations, the disclosed systems utilize the LLM to execute a wide variety of use cases by utilizing the predicted page sequences to select (or generate) digital content for client devices of users.

### BACKGROUND

In recent years, computing devices have increasingly used data analytics tools to generate content recommendations by inferring (or predicting) client device utilization behavior. For instance, some existing data analytics tools analyze client data to generate various predictions utilizing a variety of computer-based models. Oftentimes, conventional data analytics tools predict conversion probabilities, search engine recommendations, and/or interactions via computing devices. Although such conventional systems analyze and predict client behavior utilizing computer-based models, they have a number of technical shortcomings. For instance, such conventional systems are often inflexibly limited, inaccurate with limited context, and computationally inefficient.

To illustrate, conventional systems oftentimes are limited to models that generate predefined predictions from predefined inputs lengths. For instance, many conventional systems utilize machine learning (e.g., long short-term memory models) with a predetermined input length and format of input data (e.g., user data, specifically formatted tabular data) to generate client/user predictions. Furthermore, such conventional systems are limited to outputting a predefined length of output (e.g., a binary classification, retrieval). Furthermore, conventional systems often utilize machine learning models to generate specific client predictions that are not scalable to a wide variety of systems or use cases without significant modification and/or retraining (or retuning).

In addition to being inflexible, many conventional systems are also inaccurate. For instance, although conventional systems often utilize machine learning models to predict client behavior, many of these conventional systems use machine learning with limited contextual information. In many cases, conventional systems utilize document repositories and/or analytical data to generate client predictions-which oftentimes fails to generate predictions based on all available individual client contextual information. Moreover, many conventional systems generate recommendations and/or search results utilizing reactive behaviors that is retroactive and fails to capture proactive client conduct.

Moreover, conventional systems are often inefficient. For instance, many conventional systems utilize extensive training to tune machine learning models to generate client predictions from client data. As mentioned above, many of these conventional systems are focused on predetermined inputs and output formats such that individual downstream tasks require retraining a model for the particular downstream task. Accordingly, many conventional systems inefficiently utilize multiple machine learning models and training of the multiple machine learning models to implement (or execute) different downstream tasks. In addition, many conventional systems require a large set of training data to generate accurate predictions. Moreover, to scale many conventional machine learning prediction models, the models require extensive training data.

### SUMMARY

This disclosure describes one or more embodiments of systems, computer-readable media, and computer-implemented methods that solve the foregoing problems and provide other benefits. In some cases, the disclosed systems utilize digital page sequence data with large language models to generate digital page navigation predictions for client devices. In particular, in one or more implementations, the disclosed systems leverage large language models with customized page sequence input prompts to predict page sequences in additional digital navigation sessions. In addition, in one or more instances, the disclosed systems utilize large language models to generate predicted page sequences with variable lengths. Indeed, in one or more implementations, the disclosed systems tokenize page sequences from digital user navigation data and utilize the tokenized page sequences to create input prompts (e.g., zero-shot and/or few-shot input prompts) to utilize with a large language model to generate page sequence predictions. Furthermore, in some instances, the disclosed systems train a large language model to predict page sequences using a page order agnostic measure of loss. Indeed, in one or more implementations, the disclosed systems utilize the large language model to execute (or implement) a wide variety of use cases by utilizing the predicted page sequences to select (or generate) digital content for client devices of users.

### BRIEF DESCRIPTION OF THE DRAWINGS

The detailed description is described with reference to the accompanying drawings in which:

FIG. 1 illustrates a schematic diagram of an example environment in which a digital page sequence machine learning system operates in accordance with one or more implementations.

FIG. 2 illustrates an overview of a digital page sequence machine learning system utilizing page sequence data with a large language model to generate predicted page sequences in accordance with one or more implementations.

FIG. 3 illustrates a digital page sequence machine learning system generating user navigation session tokens from digital user navigation data in accordance with one or more implementations.

FIG. 4 illustrates a digital page sequence machine learning system generating an input prompt from user navigation session tokens and utilizing the input prompt with a large language model to generate a predicted page sequence in accordance with one or more implementations.

FIG. 5 illustrates a digital page sequence machine learning system training a large language model to generate predicted page sequences in accordance with one or more implementations.

FIG. 6 illustrates a digital page sequence machine learning system utilizing a predicted page sequence to select digital content for a client device in accordance with one or more implementations.

FIG. 7 illustrates a digital page sequence machine learning system utilizing the predicted page sequence to generate user segments in accordance with one or more implementations.

FIG. 8 illustrates a schematic diagram of a digital page sequence machine learning system in accordance with one or more implementations.

FIG. 9 illustrates a flowchart of a series of acts for utilizing digital page sequence data with large language models to generate digital page navigation predictions for users in accordance with one or more implementations.

FIG. 10 illustrates a block diagram of an example computing device in accordance with one or more implementations.

### DETAILED DESCRIPTION

This disclosure describes one or more implementations of a digital page sequence machine learning system that utilizes digital page sequence data with a large language model to generate digital page navigation predictions for client devices. For instance, the digital page sequence machine learning system tokenizes page sequences extracted from user navigation data to generate user navigation session tokens (e.g., one or more sub-word level tokens representing separate pages). Moreover, in one or more implementations, the digital page sequence machine learning system generates an input prompt for a large language model from the user navigation session tokens. In some cases, the digital page sequence machine learning system also extracts and utilizes training user navigation session tokens (from similar page navigation sessions) to create the input prompt (e.g., a few-shot input prompt) for the large language model. Indeed, in one or more instances, the digital page sequence machine learning system utilizes a large language model with the generated input prompt of the user navigation session tokens to generate a predicted page sequence for a user (for an additional user navigation session). Additionally, in one or more instances, the digital page sequence machine learning system utilizes a predicted page sequence to select digital content for a client device of a user corresponding to the user navigation data.

In one or more instances, the digital page sequence machine learning system tokenizes user navigation data. For example, the digital page sequence machine learning system extracts page sequence data (e.g., uniform resource locator (URL) page visits) of a user from user navigation data. Moreover, in one or more instances, the digital page sequence machine learning system converts the extracted page sequence data to a page descriptor sequence (e.g., a sequence of readable web page names or web page titles). In addition, in one or more embodiments, the digital page sequence machine learning system, utilizing a tokenizer, tokenizes the page descriptor sequence to generate a set of user navigation session tokens. In one or more instances, the digital page sequence machine learning model system utilizes multiple page tokens (e.g., sub-word level tokens) to represent a page. Moreover, in some cases, the user navigation session tokens include, but are not limited to, beginning of session tokens, source of arrival tokens, page tokens, and/or end of session tokens. Moreover, in one or more implementations, the digital page sequence machine learning system generates training data from sets of user navigation session tokens (generated from various user navigation data of a plurality of users) by creating (or segmenting) input user navigation session tokens for an input navigation session(s) and output user navigation session tokens for an output navigation session(s).

Moreover, in one or more embodiments, the digital page sequence machine learning system creates (or generates), utilizing a prompt generation model, input prompts for a large language model utilizing the set of user navigation session tokens. For instance, in some cases, the digital page sequence machine learning system generates a zero shot input prompt for a large language model by generating a prompt portion from the user navigation session tokens and a prompt portion with a request to generate the predicted page sequence based on the input user navigation session tokens. In some implementations, the digital page sequence machine learning system generates a few shot input prompt for a large language model by generating a prompt portion from the user navigation session tokens, a prompt portion from example training input-output page sequence pairs, and a prompt portion with a request to generate the predicted page sequence based on the input user navigation session tokens and the example training input-output page sequence pairs.

Furthermore, in one or more instances, the digital page sequence machine learning system utilizes the input prompt with a large language model to generate a predicted page sequence. In particular, in one or more implementations, the digital page sequence machine learning system utilizes the input prompt with a large language model to enable the large language model to generate a predicted page sequence for the user (to indicate or represent) a predicted user navigation session. For example, the predicted page sequence represents a predicted sequence of page navigations of a user the utilizing context of past navigation data of the user and training input-output page sequence pairs. In one or more embodiments, the digital page sequence machine learning system generates a predicted page sequence from the large language model with a varying length (e.g., not limited to a predefined number of actions or page visits).

In some implementations, the digital page sequence machine learning system trains a large language model to predict page sequences from user navigation session tokens. For instance, the digital page sequence machine learning system utilizes training input-output page sequence pairs to predict page sequences and generate a measure of loss to modify parameters of the large language model by comparing the predicted page sequences to the training input-output page sequence pairs (e.g., as ground truths). In one or more implementations, the digital page sequence machine learning system determines a custom, page order agnostic measure of loss from the predicted page sequence and ground truth comparisons and, further, utilizes the page order agnostic measure of loss to modify the parameters of the large language model.

Furthermore, as mentioned above, in one or more instances, the digital page sequence machine learning system utilizes a predicted page sequence to select digital content for a client device of a user corresponding to the user navigation data. For instance, the digital page sequence machine learning system utilizes generated input prompts with a large language model to execute or implement a wide variety of digital user navigation recommendation and/or digital marketing tasks. Indeed, in one or more cases, the digital page sequence machine learning system utilizes the predicted page sequences to, but not limited to, generate (or select) electronic communications for the user and/or generate (or select) selectable graphical user interface options for a client device of the user (e.g., to enable quicker execution of or provide quicker access to a target outcome). In addition, in one or more instances, the digital page sequence machine learning system utilizes predicted page sequences (of a user and other users) to segment users based on user navigation sessions similarities (e.g., a likelihood of visiting a particular page or performing particular target outcome).

The digital page sequence machine learning system can provide several advantages over conventional systems by utilizing digital page sequence data with large language models to generate digital page navigation predictions for users. For example, the digital page sequence machine learning system improves flexibility of digital user behavior prediction modeling. In particular, in one or more instances, the digital page sequence machine learning system utilizes readily available (and accessible) user navigation data (e.g., page visits) with a large language model to generate digital user navigation inferences. In addition, unlike many conventional systems that are limited to predetermined input formats and output formats, the digital page sequence machine learning system can utilize a large language model to generate predicted page sequences without a predetermined size of sequence. Moreover, in one or more implementations, the digital page sequence machine learning system utilizes a modifiable and size variable input prompt to generate the predicted page sequences to guide the large language model using past user activity data (e.g., user page visits data). Unlike conventional systems, the flexibility in input format and output format enables the digital page sequence machine learning system to scale to a wide variety of systems or use cases without significant modification of the input prompts and/or without retraining of the large language model.

Furthermore, unlike many conventional systems that are limited to utilizing document repositories when using large language model, the digital page sequence machine learning system can utilize tokens for page visit data instead of natural language input with a large language model to generate predicted user page sequences. Many conventional systems are unable to utilize large language models without using natural language prompts (making it difficult to scale in automated systems) due to the page sequence data not following natural language grammar. In contrast, in one or more implementations the digital page sequence machine learning system utilizes page visit data (e.g., page URLs) with large language models (via tokenized conversions) to generate predicted user navigation behavior. In addition, the digital page sequence machine learning system can also guide large language models using past user navigation sessions (and in some cases other similar user navigation sessions from other users). This also enables the digital page sequence machine learning system to flexibly generate predicted page sequences for a wide variety of systems or use cases without significant modification of the input prompts and/or without retraining of the large language model. Furthermore, by utilizing a large language model, in one or more embodiments the digital page sequence machine learning model system enables user modification of input prompts to generate customized prompts to generate customized predicted page sequences without utilizing complicated query language, such as SQL queries (e.g., users utilize natural language input prompt modifications).

Moreover, the digital page sequence machine learning system can also improve the accuracy of utilizing machine learning to generate page sequence predictions. For example, the digital page sequence machine learning system utilizes specific zero-shot and few-shot input formats to increase the accuracy of large language models in predicting page sequences. In addition, in one or more instances, the digital page sequence machine learning system trains the large language model utilizing a custom loss that improves the accuracy of page sequence predictions by utilizing a page order agnostic measure. Moreover, in one or more implementations, the digital page sequence machine learning system is able to utilize available user navigation session history (e.g., past page visits) (and/or other user navigation session history) as part of the input prompt to build in context for the large language model to accurately generate an accurate predicted page sequence for a user. In many cases, the digital page sequence machine learning system results in predicted user interaction behaviors that are self-defined by user navigation data to generate proactive predictions on future user behavior. Indeed, in some cases, the digital page sequence machine learning system generates predicted page sequences from users without utilizing events attached to a cookie to personalize (e.g., cookieless personalization).

Furthermore, unlike conventional systems that utilize LSTM models, in one or more implementations the digital page sequence machine learning system utilizes large language models capable of encoding semantic and syntactic information available in page names (which an LSTM does not). Moreover, in one or more instances, the digital page sequence machine learning system utilizes large language models pretrained on massive data sets allowing the models to encode relevant, external knowledge (which cannot be matched by sequence models trained with identifiers for page names). Indeed, in some implementations, the digital page sequence machine learning system utilizes tokenized page sequences to provide large language models with versatility and flexibility in generating predictions.

Additionally, the digital page sequence machine learning system can also improve the efficiency of utilizing machine learning to predict digital user navigation behavior and to execute downstream applications using the predicted digital user navigation behavior. For instance, unlike many conventional systems that utilize different components or machine learning models to train (or generate) different inferences for downstream tasks, in one or more implementations the digital page sequence machine learning system utilizes the output predicted page sequence data from the singular large language model to execute a variety of downstream tasks. In particular, due to the flexibility in input format and output format, the digital page sequence machine learning system enables the output predicted page sequence to be utilized by a variety of downstream tasks (with increased computational efficiency). In addition, the digital page sequence machine learning system also enables scalable utilization across multiple systems (due to the modifiable zero-shot and few-shot input format) with less configuration which enables efficient utilization of the large language model without significant modification to input formats and/or retraining. Therefore, unlike many conventional systems that utilize different models trained for individual tasks, in one or more implementations the digital page sequence machine learning system improves efficiency by enabling a singular large language model to generate predicted page sequences that are useable with a variety of downstream tasks. In addition, in one or more instances, the digital page sequence machine learning system utilizes widely available user navigation data (e.g., page URL visits) such that the digital page sequence machine learning system generates training data is easily obtainable and lightweight (e.g., to reduce computation time and storage space).

As used herein, the term “user navigation data” refers to information of user interactions with a website and/or digital application between one or more interfaces. For example, user navigation data includes page views, click paths, session durations, timestamps, exit pages, source of arrival data, time on page data, and/or click paths. In one or more instances, the user navigation data includes page view through page URL visits of users and timestamps for the user. In some cases, user navigation data includes video streaming views and/or other digital content views. In one or more instances, the digital page sequence machine learning model system identifies (or receives) user navigation data specific to a website or digital application to generate page visit, page sequence, and/or user navigation session token data for the particular website and/or digital application.

In addition, as used herein, the term “page visit” (or sometimes referred to as “page visit”) refers to an action denoting that a client device viewed or visited a particular page (or interface) corresponding to a particular URL. In one or more instances, a page visit includes a URL of the page and a timestamp indicating a time of visit by a client device corresponding to the user. In some cases, page visit data also includes user metadata (e.g., location data, browser data, operating system data).

Furthermore, as used herein, the term “user navigation session” refers to a sequence of page visits of a client device corresponding to a user. Indeed, in one or more embodiments, a user navigation session includes a sequence of page visits that represents or forms a user journey in one or more websites and/or digital applications. Indeed, as used herein, the term “page sequence” refers to a set of page visits by a client device corresponding to a user within a website and/or digital application. For example, the page sequence includes various numbers of page visits in chronological order or as an unordered set (indicating which pages were visited by a user during a navigation session).

As used herein, the term “user navigation session token” (or sometimes referred to as “session token”) refers to a unit of text that represents (portions of or an entirety of) page descriptors and/or source of arrival data for user navigation sessions (e.g., as sub-word level tokens). Indeed, in one or more cases, the digital page sequence machine learning system utilizes user navigation session tokens to break down page descriptors (e.g., a page name) and/or source of arrival data (or other data) into smaller units for utilization in a large language model. For example, a user navigation session token includes one or more page tokens that represent an individual page (e.g., sub-word level tokens that break a page name into separate words or descriptors). Indeed, in one or more implementations, the digital page sequence machine learning model system represents a user navigation session by generating multiple user navigation session tokens that include a source of arrival token, beginning of session token, various sets of page tokens to represent one or more pages, and an end of session token. In one or more implementations, the digital page sequence machine learning model system utilizes a tokenizer to generate the user navigation session token(s). For instance, a tokenizer includes a model (e.g., machine learning, rule-based, tree-based), an algorithm, and/or a set of instructions that transform or convert page descriptors and/or other data (in accordance with one or more implementations herein) to sub-word level tokens.

As used herein, the term “language machine learning model” refers to a machine learning model that analyzes a language input (e.g., text or verbal input) to generate a predicted output. For instance, the digital page sequence machine learning system utilizes a variety of language machine learning model architectures, such as a large language model. For example, a large language model processes natural language text to generate outputs that range from predictive outputs and/or natural language analyses of the predictive outputs. In particular, in one or more implementations, a large language model can include a transformer neural network architecture having parameters trained (e.g., via deep learning) on data to learn patterns and rules of user page sequences to generate predicted page sequences. Examples of large language model include bidirectional encoder representations (BERT), Sentence-BERT, ChatGPT (e.g., GPT-3, GPT-4, etc.), Llama2, T5 encoder-decoder models, other text transformer models, and/or other word processing machine learning models.

As used herein, the term “input prompt” refers to a set of input instructions to a large language model (or other machine learning model) to cause the large language model to generate a particular output (or perform a particular task). Indeed, a prompt can include an input string of text that includes request for a large language model (e.g., to generate a predicted page sequence) with context from sample page sequences corresponding to the user and/or other users. In one or more cases, an input prompt can include a machine generated text input and/or a user generated text input or voice command. For instance, the digital page sequence machine learning model system utilizes a prompt generation model to generate an input prompt utilizing one or more prompt templates and/or user navigation session tokens in accordance with one or more implementations herein. For example, a prompt generation model includes a model (e.g., machine learning, rule-based, tree-based), an algorithm, and/or a set of instructions that transform or converts one or more prompt templates, user navigation session tokens, and/or other input descriptor (e.g., text or voice data) into an input prompt (in accordance with one or more implementations herein).

As used herein, the term “machine learning model” refers to a computer algorithm or a collection of computer algorithms that automatically improve for a particular task through experience based on use of data. For example, a machine learning model utilizes one or more learning techniques to improve in accuracy and/or effectiveness. Example machine learning models include various types of decision trees, support vector machines, Bayesian networks, linear regressions, logistic regressions, random forest models, time series model, pairwise products model, or neural networks. Indeed, in some instances, a machine learning model includes a transformer-based models (e.g., large language models), long short-term memory model, a convolutional neural network (CNN) model, or a recurrent neural network (RNN) model.

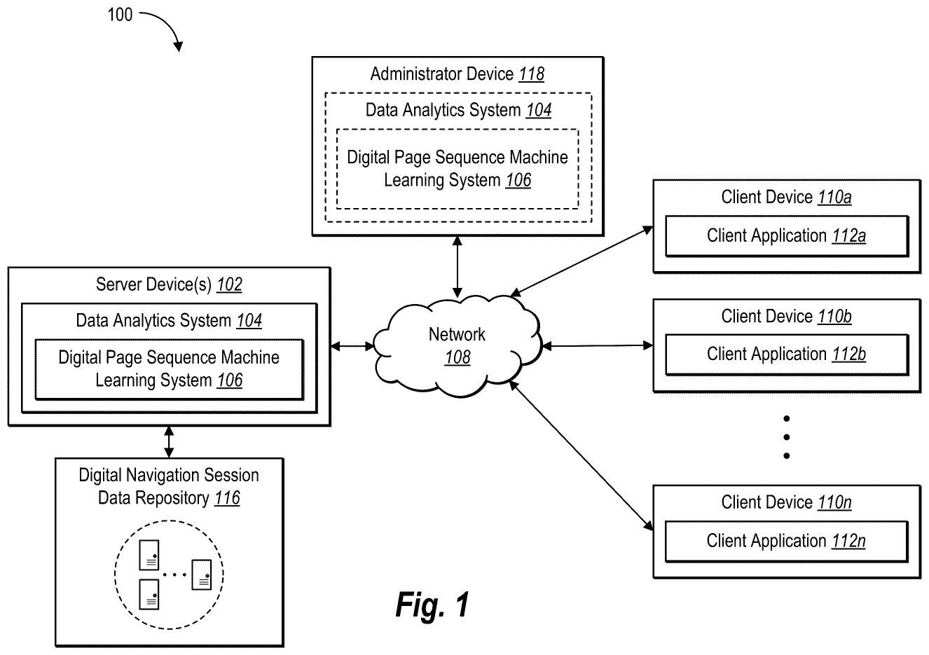

Turning now to the figures, FIG. 1 illustrates a schematic diagram of one or more implementations of a system 100 (or environment) in which a digital page sequence machine learning system operates in accordance with one or more implementations. As illustrated in FIG. 1, the system 100 includes a server device(s) 102, a network 108, a client devices 110a-110n, an administrator device 118, and digital navigation session data repository 116. As further illustrated in FIG. 1, the server device(s) 102, the client devices 110a-110n, the administrator device 118, and the digital navigation session data repository 116 communicate via the network 108.

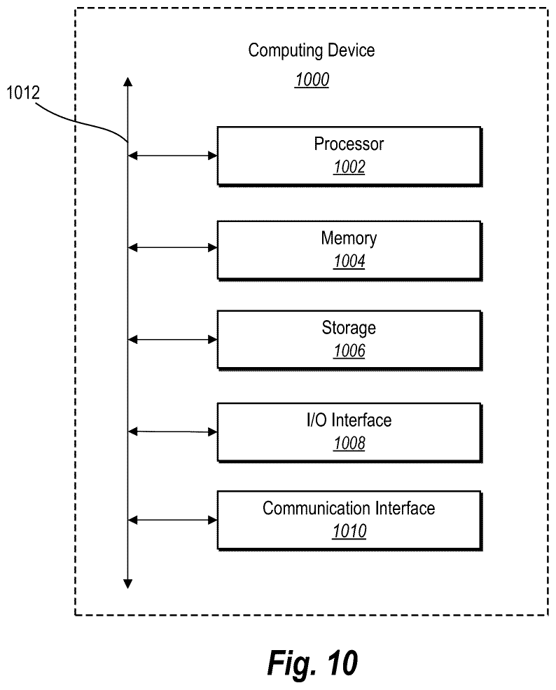

In one or more implementations, the server device(s) 102 includes, but is not limited to, a computing (or computer) device (as explained below with reference to FIG. 10). As shown in FIG. 1, the server device(s) 102 include a data analytics system 104 which further includes the digital page sequence machine learning system 106. The data analytics system 104 can generate, train, store, deploy, and/or utilize various machine learning models for various machine learning applications, such as, but not limited to, regression tasks, digital navigation behavior, classification tasks, text recognition tasks, voice recognition tasks, artificial intelligence tasks, and/or other data analytics tasks (e.g., conversion predictions, user affinity predictions, user-content affinity predictions, user-product affinity predictions). In addition, in one or more instances, the data analytics system 104 generates a variety of graphical user interfaces and/or digital content for the above-mentioned machine learning applications (and/or data analytics applications).

Moreover, as explained below, the digital page sequence machine learning system 106, in one or more embodiments, utilizes digital page sequence data with a large language model to generate digital page navigation predictions for users. In some implementations, the digital page sequence machine learning system 106 tokenizes page sequences extracted from user navigation data (e.g., from the digital navigation session data repository 116 and/or the client devices 110a-110n) to generate user navigation session tokens. Moreover, in one or more instances, the digital page sequence machine learning system 106 generates input prompts from the user navigation session tokens and utilizes the input prompt with a large language model to generate predicted page sequences. Indeed, in one or more embodiments, the digital page sequence machine learning system 106 utilizes the predicted page sequences to select (or generate) digital content for the client devices 110a-110n.

Furthermore, as shown in FIG. 1, the system 100 includes the client devices 110a-110n. In one or more implementations, the client devices 110a-110n includes, but is not limited to, a mobile device (e.g., smartphone, tablet), a laptop, a desktop, or any other type of computing device, including those explained below with reference to FIG. 10. In certain implementations, although not shown in FIG. 1, the client devices 110a-110n is operated by a user to perform a variety of functions (e.g., via a digital application). For example, the client devices 110a-110n performs functions such as, but not limited to, interacting with one or more graphical user interfaces for websites and/or applications, displaying media content items (e.g., images, videos, text), and/or enabling electronic communications. In some instances, the client devices 110a-110n also generate and/or provide data, such as, but not limited to user navigation data (e.g., click stream data, cookie data) to the server device(s) 102 (for utilizing by the data analytics system 104 and/or the digital page sequence machine learning system 106).

To view or access the functionalities or content generated the digital page sequence machine learning system 106 (as described above), in one or more implementations, a user interacts with the digital application on the client devices 110a-110n. For example, the digital application includes one or more software applications installed on the client devices 110a-110n (e.g., client applications 112a-112n) to perform functionalities, such as but not limited to, interacting with one or more graphical user interfaces for websites and/or applications, displaying media content items (e.g., images, videos, text), enabling electronic communications, and/or generating digital user navigation data in accordance with one or more implementations herein. In some cases, the digital applications (e.g., client applications 112a-112n) are hosted on the server device(s) 102. In addition, when hosted on the server device(s) 102, the client applications 112a-112n are accessed by the client devices 110a-110n through a web browser and/or another online interfacing platform and/or tool.

As further shown in FIG. 1, the system 100 includes the administrator device 118. In one or more implementations, the administrator device 118 includes, but is not limited to, a mobile device (e.g., smartphone, tablet), a laptop, a desktop, or any other type of computing device, including those explained below with reference to FIG. 10. In one or more implementations, although not shown in FIG. 1, the administrator device 118 is operated by an administrator user to perform a variety of functions (e.g., via a digital application). For instance, the administrator device 118 performs functions, such as, but not limited to, configuring various parameters of the digital page sequence machine learning system, configuring or implementing a large language model, and/or configuring digital navigation session data. Moreover, the administrator device 118 also performs functions, such as, but not limited to, displaying graphical user interfaces for predicted page sequences, displaying graphical user interfaces for data analytics or reports generated from predicted page sequences (in accordance with one or more implementations herein), and/or displaying graphical user interfaces to configure the various aspects of the data analytics system 104 and/or the digital page sequence machine learning system 106.

To view or access the functionalities or content generated the digital page sequence machine learning system 106 (as described above), in one or more implementations, an administrator user interacts with an administrator digital application on the administrator device 118. For example, the administrator digital application includes one or more software applications installed on the administrator device 118 to perform the above-mentioned functionalities. In some cases, the administrator digital application is hosted on the server device(s) 102. In addition, when hosted on the server device(s) 102, the administrator digital application is accessed by the administrator device 118 through a web browser and/or another online interfacing platform and/or tool. In some cases, as shown in FIG. 1, the administrator device hosts or implements the data analytics system and/or the digital page sequence machine learning system 106.

Although FIG. 1 illustrates the digital page sequence machine learning system 106 being implemented by a particular component and/or device within the system 100 (e.g., the server device(s) 102), in some implementations, the digital page sequence machine learning system 106 is implemented, in whole or in part, by other computing devices and/or components in the system 100. For example, in some implementations, the digital page sequence machine learning system 106 is implemented on the administrator device 118. Indeed, in one or more implementations, the description of (and acts performed by) the digital page sequence machine learning system 106 are implemented (or performed by) administrator device 118 when the administrator device 118 implements the digital page sequence machine learning system 106. More specifically, in some instances, the administrator device 118 (via an implementation of the digital page sequence machine learning system 106 on a digital application of the administrator device 118) utilizes digital page sequence data with a large language model to generate digital page navigation predictions for users.

As further shown in FIG. 1, the system 100 includes a digital navigation session data repository 116. For instance, the digital navigation session data repository 116 includes one or more storage devices (or systems) that process, create, and/or store digital user activity (or navigation) data from the client devices 110a-110n. In some cases, the digital navigation session data repository 116 includes data received form the client devices 110a-110n. In some instances, the digital navigation session data repository 116 includes existing page sequence data (e.g., from an existing data set or training data set). For example, the digital navigation session data repository 116 includes historical navigation session data collected by the data analytics system 104 from user interactions received from the client devices 110a-110n and/or third-party digital navigation session data. In one or more implementations, the digital navigation session data repository 116 includes, but is not limited to, a computing (or computer) device (as explained below with reference to FIG. 10).

Additionally, as shown in FIG. 1, the system 100 includes the network 108. As mentioned above, in some instances, the network 108 enables communication between components of the system 100. In certain implementations, the network 108 includes a suitable network and may communicate using any communication platforms and technologies suitable for transporting data and/or communication signals, examples of which are described with reference to FIG. 10. Furthermore, although FIG. 1 illustrates the server device(s) 102, the client devices 110a-110n, the administrator device 118, and/or the digital navigation session data repository 116 communicating via the network 108, in certain implementations, the various components of the system 100 communicate and/or interact via other methods (e.g., the server device(s) 102 and the administrator device 118 communicating directly).

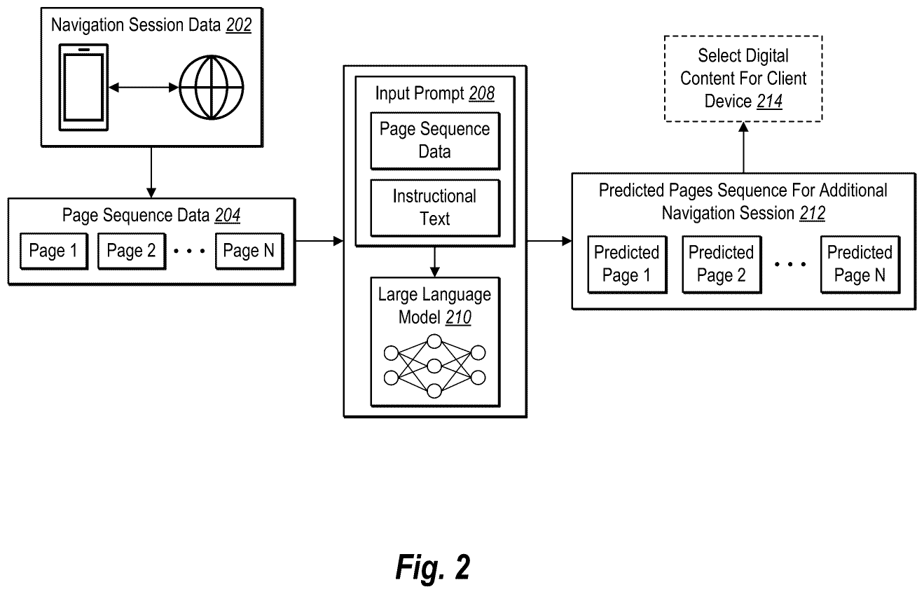

As mentioned above, the digital page sequence machine learning system 106 utilizes digital page sequence data with a large language model to generate digital page navigation predictions for users. For instance, FIG. 2 illustrates an overview of the digital page sequence machine learning system 106 utilizing page sequence data with a large language model to generate predicted page sequences for additional navigation sessions for a user.

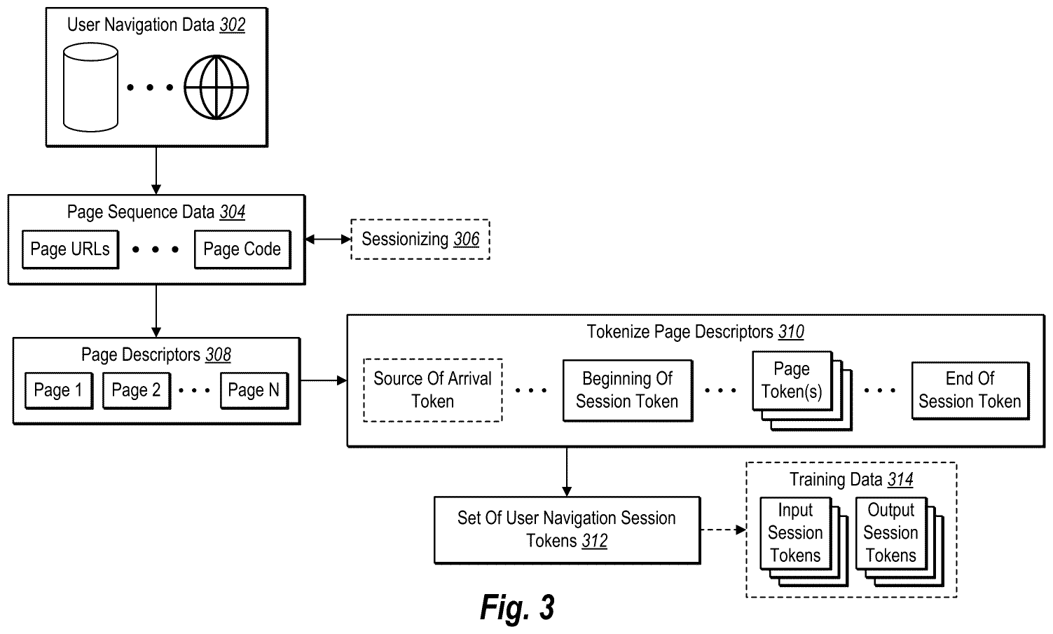

For instance, as shown in FIG. 2, the digital page sequence machine learning system 106 generates page sequence data 204 from navigation session data 202. In some cases, the digital page sequence machine learning system 106 tokenizes page sequence descriptors determined from the navigation session data 202 as the page sequence data 204 (e.g., user navigation session tokens). Indeed, the digital page sequence machine learning system 106 generates page sequence data as described below (e.g., in relation to FIG. 3).

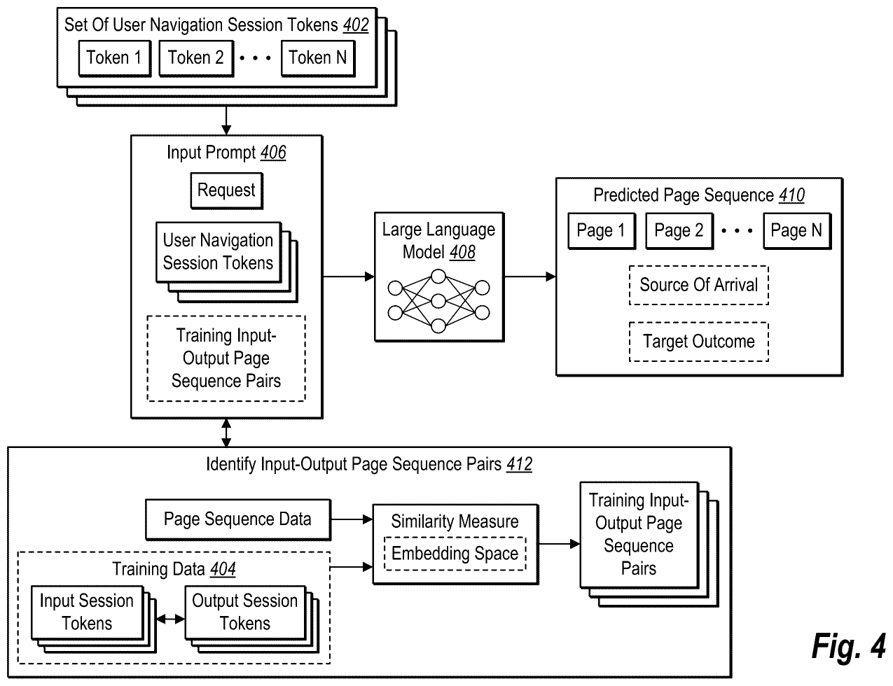

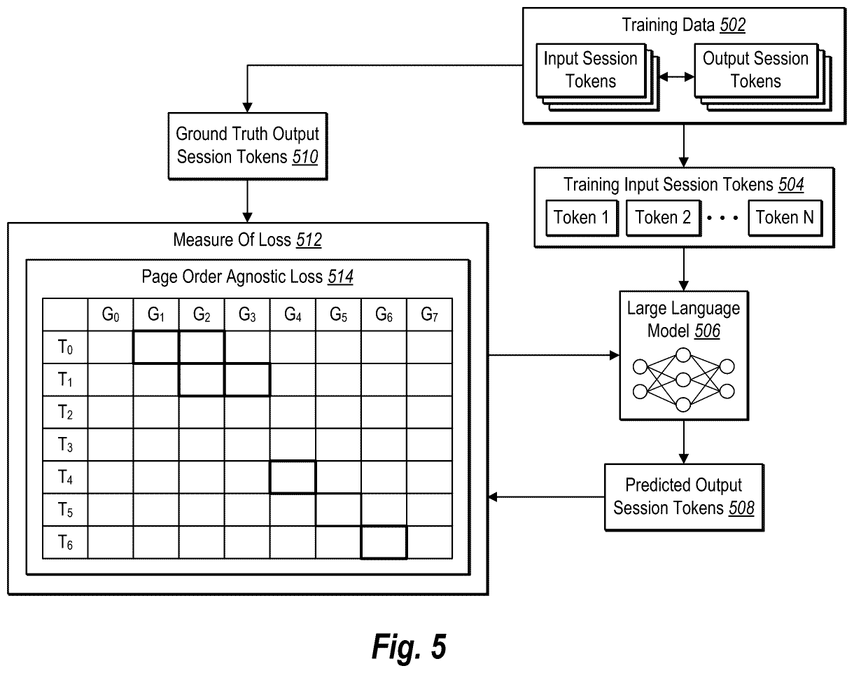

Moreover, as shown in FIG. 2, the digital page sequence machine learning system 106 generates an input prompt 208 from the page sequence data 204. In some cases, the digital page sequence machine learning system 106 generates an input prompt by generating, as a prompt portion, page sequence data (from the page sequence data 204) and instructional text that requests the generation of a predicted page sequence. Moreover, as shown in FIG. 2, the digital page sequence machine learning system 106 utilizes the input prompt 208 with the large language model 210 to generate a predicted page sequence 212 for an additional navigation session (for a user of a client device). Indeed, the digital page sequence machine learning system 106 generates an input prompt and utilizes the input prompt with a large language model to generate a predicted page sequence as described below (e.g., in relation to FIGS. 4 and 5).

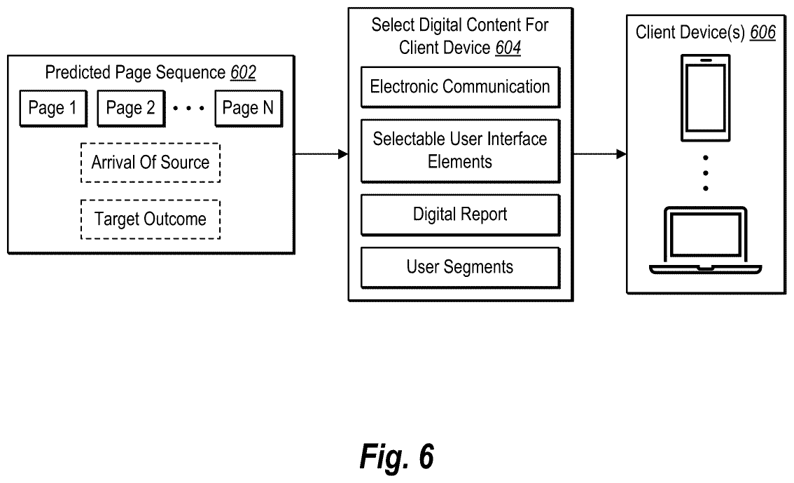

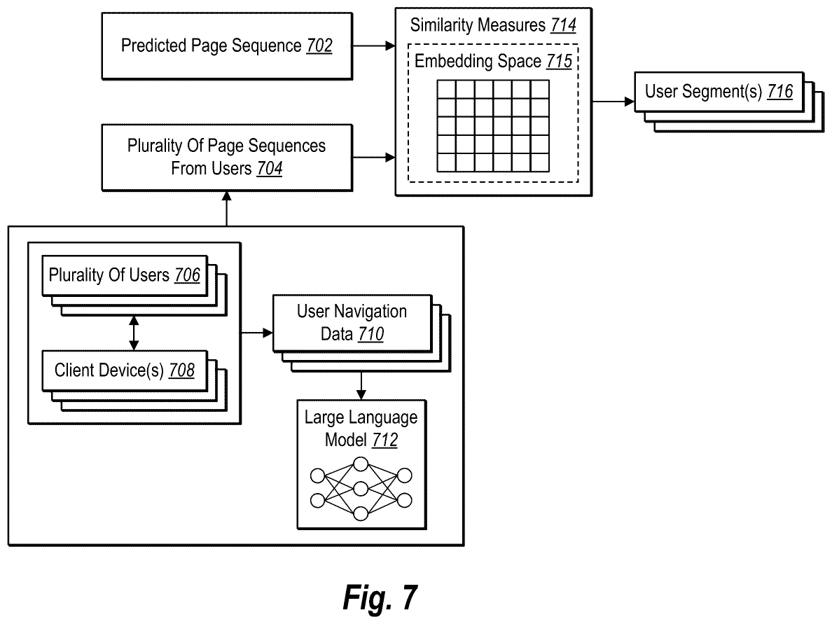

In some implementations, as shown in an act 214 of FIG. 2, the digital page sequence machine learning system 106 utilizes the predicted page sequence 212 to select (or generate) digital content for a client device of the user. For instance, as mentioned above, the digital page sequence machine learning system 106 utilizes the predicted page sequences to select (or create) digital content for electronic communications for the user, selectable graphical user interface options for a client device of the user, and/or user segments based on user navigation session similarities. Indeed, the digital page sequence machine learning system 106 utilizes predicted page sequences to select (or generate) digital content as described below (e.g., in relation FIGS. 6 and 7).

As mentioned above, in one or more instances, the digital page sequence machine learning system 106 tokenizes digital user navigation data. For instance, FIG. 3 illustrates the digital page sequence machine learning system 106 generating user navigation session tokens from digital user navigation data. In particular, FIG. 3 illustrates the digital page sequence machine learning system 106 identifying page sequence data from user navigation data, converting the page sequence data to page descriptors, and tokenizing the page descriptors to generate a set of user navigation tokens.

Indeed, as shown in FIG. 3, the digital page sequence machine learning system 106 identifies (or receives) user navigation data 302. Moreover, as shown in FIG. 3, the digital page sequence machine learning system 106 extracts (or identifies) page sequence data 304 from the user navigation data 302 (e.g., page URLs, page code). In addition, as shown in FIG. 3, the digital page sequence machine learning system 106 converts the page sequence data 304 to page descriptors 308 (e.g., a natural language descriptor for elements from the page sequence data).

As further shown in act 310 of FIG. 3, the digital page sequence machine learning system 106 tokenizes the page descriptors 308 (e.g., utilizing a tokenizer). Indeed, as shown in FIG. 3, the digital page sequence machine learning system 106 generates tokens from the page descriptors 308, such as a beginning of session token, page token(s), and an end of session token. In some instances, as shown in the act 310, the digital page sequence machine learning system 106 also generates a source of arrival token. As shown in FIG. 3, the digital page sequence machine learning system 106 tokenizes the page descriptors 308 to generate a set of user navigation tokens 312.

In one or more instances, the digital page sequence machine learning system 106 identifies (or receives) digital user navigation data from digital user activities on one or more websites or digital applications. For example, the digital page sequence machine learning system 106 identifies (or receives) clickstream data from a client device that indicates user activity taken on a website or a digital application (e.g., page views, clicks, actions). In some cases, the digital user navigation data includes, but is not limited to, referring URLs (sources), visited pages (or page URLs), click paths, exit pages, mouse movements, click rates, scroll actions, and/or button actions. In some instances, the digital page sequence machine learning system 106 receives the user navigation data from an administrator device (or system device) of an entity that operates a particular website or digital application (e.g., to receive data analytics for the particular website or digital application). In one or more instances, the digital page sequence machine learning system 106 receives the user navigation data from a third-party system that collects, extracts, organizes, and/or generates user navigation data for one or more websites and/or digital applications.

In some instances, for training data, the digital page sequence machine learning system 106 identifies training datasets of user navigation data. For instance, the digital page sequence machine learning system 106 identifies repositories or data sets that store raw user interactions with one or more websites and/or digital applications. Indeed, in one or more instances, the digital page sequence machine learning system 106 identifies training datasets of user navigation data from accessible repositories that contain user interaction data (e.g., timestamped data for user activities on one or more websites and/or digital applications).

In some instances, the digital page sequence machine learning system 106 identifies (or receives), as part of the digital user navigation data, page sequence data. For example, the digital page sequence machine learning system 106 identifies page sequence data, such as, but not limited to page URLs visited by a user from user activity corresponding to a client device of the user. In addition, in one or more cases, the digital page sequence machine learning system 106 identifies timestamps for the page URL visits. In some instances, the digital page sequence machine learning system 106 identifies URL page visits for multiple users over multiple sessions. For example, the digital page sequence machine learning system 106 identifies or receives an array of page URLs visited by one or more client devices of a user from activity on a website and/or a mobile application. Moreover, in some implementations, the digital page sequence machine learning system 106 also identifies a source or referrer (e.g., a search engine, an electronic communication, a shared URL link, a QR code) of a first navigation (e.g., page) in a session.

Although one or more embodiments herein describe the digital page sequence machine learning system 106 utilizing page URLs, the digital page sequence machine learning system 106, in some cases, identifies a page code as the page sequence data. For instance, the digital page sequence machine learning system 106 identifies mobile application log data (e.g., breadcrumbs, screen visits) and/or user interface view data (as page code data) to utilize as page sequence data (e.g., to determine user navigation within a digital application).

In some instances, as shown in the act 306 of FIG. 3, the digital page sequence machine learning system 106 sessionizes page sequence data to generate (or identify) separate user navigation sessions on a website and/or a digital application. For instance, the digital page sequence machine learning system 106 utilizes timestamp data corresponding to the page sequence data (e.g., timestamps for individual page URL visits) to determine a user navigation session. For instance, in some cases, the digital page sequence machine learning system 106 utilizes a threshold time gap between page URL visits to segregate sequences of page visits from the page sequence data into user navigation sessions. For example, the digital page sequence machine learning system 106 determines a sequence of page URL visits that, each, are within a threshold time gap apart to determine that the sequence of page URL visits belong to a singular user navigation session.

In some cases, the digital page sequence machine learning system 106 identifies, from a sequence of page URL visits, when a time gap between a page URL visit and a subsequent page URL visit is more than a threshold time gap apart to segment the sequence of page URL visits from the subsequent page URL (to generate the user navigation session). Likewise, in one or more instances, the digital page sequence machine learning system 106 utilizes the threshold time gap to identify a beginning page URL visit for a user navigation session (by identifying a starting page URL visit that is more than the threshold time gap apart from a preceding page URL visit).

In addition, in one or more implementations, the digital page sequence machine learning system 106 generates page descriptors (e.g., page descriptors 308). For instance, the digital page sequence machine learning system 106 utilizes the page sequence data to generate page descriptors that map (or convert) the page URLs (or other page code) to readable, natural language descriptors. For example, the digital page sequence machine learning system 106 utilizes a mapping (e.g., a dictionary mapping) corresponding to a particular website and/or digital application between page URLs and a page name (or page title) to generate the page descriptors. For instance, the digital page sequence machine learning system 106 utilizes the page names or titles mapped to the page URLs as the page descriptors. As an example, the digital page sequence machine learning system 106 utilizes a mapping, from the website and/or digital application, that maps particular URLs to particular page names (e.g., www.company1.com/% 4303/prd1/8484888 maps to “Product 1 Page” and www.company1.com/% 4429/srv/maps to “Service Page”).

In some instances, the digital page sequence machine learning system 106 utilizes a page descriptor function to generate page descriptors from a page URL. For example, the digital page sequence machine learning system 106 modifies a page URL to generate a page descriptor. Indeed, in some implementations, the digital page sequence machine learning system 106 removes special characters and/or symbols from a page URL to generate a meaningful page descriptor. As an example, the digital page sequence machine learning system 106 modifies a page URL (e.g., www.company1.com/men+t+shirt/12455/blue/1222/cotton”) to generate a page descriptor (e.g., “men t shirts blue cotton”).

In some cases, the digital page sequence machine learning system 106 utilizes page URLs (or code) to generate a page descriptor from a webpage or digital application interface corresponding to the page URL (or code). For instance, the digital page sequence machine learning system 106 utilizes machine learning to analyze a webpage or digital application interface corresponding to the page URL (or code) to generate a page descriptor for the webpage or digital application interface corresponding to the page URL (or code). Indeed, in one or more instances, the digital page sequence machine learning system 106 utilizes the generated page descriptors as the page descriptors 308 (in reference to FIG. 3).

In one or more instances, the digital page sequence machine learning system 106 generates a page sequence by creating an order for the page descriptors based on a time stamp associated with the page descriptors (or the page URL visits). Indeed, in one or more cases, the digital page sequence machine learning system 106 generates the page sequence to indicate a user navigation journey (e.g., in a navigation session) that represents a path of page visits of a user (e.g., a browsing history) during the navigation session.

In one or more implementations, the digital page sequence machine learning system 106 modifies the page sequence of page descriptors to control sequence length. For example, the digital page sequence machine learning system 106 removes successive duplicate page descriptors to control for repetition and/or sequence length. Indeed, in some implementations, the digital page sequence machine learning system 106 utilizes a similarity measure between the page descriptors to identify duplicate page descriptors. For example, the digital page sequence machine learning system 106 utilizes cosine similarities between word embeddings generated from the page descriptors to identify duplicate page descriptors. For instance, the digital page sequence machine learning system 106 utilizes word embeddings generated from machine learning models, such as, but not limited to bidirectional encoder representations (BERT), Sentence-BERT, other text transformer models, and/or other word processing machine learning models.

Furthermore, as shown in FIG. 3, the digital page sequence machine learning system 106, utilizing a tokenizer, tokenizes page descriptors to generate user navigation tokens. For instance, the digital page sequence machine learning system 106 tokenizes page descriptors to improve efficient utilization of the page sequence data with large language models. For example, the digital page sequence machine learning system 106 tokenizes the page descriptors into tokens as input for a large language model.

To illustrate, in one or more implementations, the digital page sequence machine learning system 106 generates special tokens to represent a page sequence in a user navigation session. In one or more instances, the digital page sequence machine learning system 106 generates tokens to represent a user navigation session in a particular format that indicates a beginning of a session, page visits in a session, and/or an end of a session. In some cases, the digital page sequence machine learning system 106 also generates a source of arrival token to indicate a source page (or method) utilized to access or begin the user navigation session. In one or more embodiments, the digital page sequence machine learning system 106 also utilizes a variety of other tokens to represent one or more additional aspects of a user navigation session (e.g., scroll actions, click actions, inputs, refreshes).

As an example, the digital page sequence machine learning system 106 tokenizes a user navigation session (e.g., the page descriptors of a sequence of pages) utilizing the following token format: [SRC] source page [BOS] page1 page2 . . . pageK [EOS], in which [SRC] denotes arrival of source token (e.g., for a first page of a session or a referring source to enter the first page), [BOS] denotes a beginning of a session, and [EOS] denotes an end of a session. As another example, the digital page sequence machine learning system 106 generates a tokenized page sequences from page sequence data for one or more sessions (e.g., user navigation session tokens) using the following token format: [SRC] search engine name [BOS] home—drinkware—home [EOS]; [SRC] (direct) [BOS] home—drinkware—mugs—checkout—cups—bags—home—checkout [EOS]; [SRC] referral [BOS] home—backpacks—home [EOS]. In addition, as an additional example, the digital page sequence machine learning system 106 generates tokenized page sequences from page sequence data for one or more sessions (e.g., user navigation session tokens) using the following token format: [SRC] external [BOS] ru ru company1.com gallery—ru ru company1.com gallery popup—ru ru [EOS]; [SRC] external [BOS] ru ru company1.com gallery—ru ru company1.com gallery popup—ru ru company1.com profile default—ru ru [EOS].

In one or more implementations, the digital page sequence machine learning system 106 generates user navigation tokens from page sequence data for a plurality of users over a plurality of identified navigation sessions for the plurality of users. Moreover, in some cases, the digital page sequence machine learning system 106 generates a data set of the user navigation tokens (for the page sequences of the navigation sessions). Furthermore, as shown in FIG. 3, in some instances, the digital page sequence machine learning system 106 utilizes a data set of user navigation tokens to generate training data 314. For instance, the digital page sequence machine learning system 106 utilizes tokens corresponding to multiple navigation sessions of one or more users to generate input session tokens (e.g., one or more test or training user navigation session token sequences) and ground truth output session tokens (e.g., one or more ground truth outcome user navigation session token sequences). Indeed, in one or more instances, the digital page sequence machine learning system 106 utilizes the training data 314 to provide sample training examples of user navigation session(s) (via the input session tokens) and resulting additional user navigation session(s) (via the output input session tokens) in context of the input session tokens (e.g., for users). Indeed, the digital page sequence machine learning system 106 generates multiple training data pairs (e.g., training input-output page sequence pairs) from user navigation data from a plurality of users interacting with a variety of websites and/or digital applications. In some cases, the digital page sequence machine learning system 106 utilizes the training data 314 (e.g., the training input-output page sequence pairs) to generate few-shot prompts for a large language model (as described in FIG. 4) and/or train a large language model to predict page sequences for users (as described in FIG. 5).

As mentioned above, in one or more instances, the digital page sequence machine learning system 106 generates an input prompt from user navigation session tokens to utilize with a large language model to generate predicted page sequences (e.g., utilizing a prompt generation model). For example, FIG. 4 illustrates the digital page sequence machine learning system 106 generating an input prompt from user navigation session tokens for a large language model. In addition, FIG. 4 illustrates the digital page sequence machine learning system 106 utilizing the input prompt with the large language model to generate a predicted page sequence.

As shown in FIG. 4, the digital page sequence machine learning system 106 generates an input prompt 406 from a set of user navigation session tokens 402 (generated as described above). For instance, the digital page sequence machine learning system 106 generates the input prompt 406 by generating a portion of the prompt using the user navigation session token(s) from the set of user navigation session tokens 402 that represent one or more user navigation sessions of a user. For instance, the digital page sequence machine learning system 106 utilizes the portion of the prompt with the user navigation session token(s) to provide context to the large language model for one or more existing (or identified) user navigation sessions of the user.

In addition, as shown in FIG. 4, the digital page sequence machine learning system 106 also generates the input prompt 406 by generating a portion of the prompt using a request. For instance, the digital page sequence machine learning system 106 generates a request (e.g., using instruction text) to instruct (or prompt) the large language model to generate a predicted page sequence for a user by utilizing the provided user navigation session token(s) as context for the user's navigation sessions. For instance, the digital page sequence machine learning system 106 generates the request portion of the input prompt with instructional text requesting to generate the predicted page sequence based on input sessions represented by the user navigation session token(s).

Furthermore, as shown in FIG. 4, the digital page sequence machine learning system 106 utilizes the input prompt 406 with a large language model 408 to generate a predicted page sequence 410. As shown in FIG. 4, the digital page sequence machine learning system 106 utilizes the large language model 408 with the input prompt 406 to generate a sequence of page navigations (e.g., Page 1, Page 2, . . . , Page N) as the predicted page sequence 410 for a user corresponding to the user navigation session tokens from the input prompt 406. As further shown in FIG. 4, the digital page sequence machine learning system 106 utilizes the large language model 408 with the input prompt 406 to generate a predicted source of arrival as part of the predicted page sequence 410. Moreover, as also shown in FIG. 4, the digital page sequence machine learning system 106 utilizes the large language model 408 with the input prompt 406 to generate a target outcome (e.g., exit website action, conversion, add-to-cart action, viewing a digital content item (video, image)) as part of the predicted page sequence 410.

For instance, the digital page sequence machine learning system 106 generates a zero-shot input prompt for a large language model utilizing request instructions and user navigation session tokens of a user (e.g., utilizing a prompt generation model). In particular, in one or more embodiments, the digital page sequence machine learning system 106 generates an input prompt that includes sets of user navigation session tokens for one or more sample input user navigation sessions with a request to generate a predicted page sequence for a user by utilizing the provided user navigation session token(s) as context for the user's navigation sessions. As an example, the digital page sequence machine learning system 106 generates a zero-shot input prompt for the large language model utilizing the following template:

| | |
|---|---|
| ### Instructions: | |
| {sample - instruction} | |
| ### Input: | |
| Given sessions: | (1) |
| {sample - input} | |
| ### Response: | |
| Next Session: | |

As an example, in the above mentioned template (1), the digital page sequence machine learning system 106 generates an exemplary input prompt of “A user's website browsing sequence of pages over multiple sessions is given below. [SRC] denotes the source of session, [BOS] denotes beginning of session, [EOS] denotes end of session. Based on activity in the Given sessions, predict the Next session as a sequence of pages in the same format. Start with [SRC], end a [EOS]. No additional text.”

Although a particular example and template is illustrated above, in one or more instances, the digital page sequence machine learning system 106 utilizes various templates and/or input prompts, as zero-shot input prompts with the one or more sample input user navigation sessions, with a large language model to generate predicted page sequences for a user. For example, the digital page sequence machine learning system 106 utilizes various numbers of sample input user navigation sessions in an input prompt.

In some implementations, the digital page sequence machine learning system 106 generates a few-shot input prompt for a large language model utilizing request instructions, user navigation session tokens of a user, and one or more training user navigation session tokens (e.g., utilizing a prompt generation model). For example, the digital page sequence machine learning system 106 generates an input prompt that includes sets of user navigation session tokens for one or more sample input user navigation sessions of a user, one or more additional training input-output page sequence pairs (e.g., as shown in FIG. 4) with a request to generate a predicted page sequence for a user by utilizing the provided user navigation session token(s) as context for the user's navigation sessions and the one or more additional training input-output page sequence pairs as context on outputs. As an example, the digital page sequence machine learning system 106 generates a few-shot input prompt for the large language model utilizing the following template:

| | |
|---|---|
| {sample - instruction} | |
| Input: {Similar input - 1} | |
| Output: {output - 1} | |
| Input: {Similar input - 2} | |
| Output: {output - 2} | (2) |
| Input: {Similar input - 3} | |
| Output: {output - 3} | |
| Predict next session for user Input: {sample - input} | |
| Output: | |

As an example, in the above mentioned template (2), the digital page sequence machine learning system 106 generates an exemplary input prompt of “A user's website browsing sequence of pages over multiple sessions is given below. [SRC] denotes the source of session, [BOS] denotes beginning of session, [EOS] denotes end of session. Based on activity in the given input sessions, predict the next session as a sequence of pages highly likely to be visited by the user. Learn from similar users' browsing sequences given below.”

Although a particular example and template is illustrated above, in one or more instances, the digital page sequence machine learning system 106 utilizes various templates, input prompts, and/or training input-output page sequence pairs, as few-shot input prompts with the one or more sample input user navigation sessions, one or more training input-output page sequence pairs with a large language model to generate predicted page sequences for a user. For example, the digital page sequence machine learning system 106 utilizes various numbers of sample input user navigation sessions (of the user) and/or training input-output page sequence pairs in an input prompt.

In one or more instances, the digital page sequence machine learning system 106 determines training input-output page sequence pairs to utilize in an input prompt for a user utilizing similarity measures between the page sequence data of the user and training data generated from user navigation data of one or more additional users. For instance, as shown in the act 412 of FIG. 4, the digital page sequence machine learning system 106 determines similarity measures between page sequence data (e.g., page names, user navigation session tokens) corresponding to the user and training page sequence data from training data 404 (e.g., training page names of input/output sessions, user training navigation session tokens of input/output sessions) to identify page sequence data similar to that of the user. Subsequently, the digital page sequence machine learning system 106 utilizes the selected (or identified) similar training input/output sessions as the one or more training input-output page sequence pairs within the input prompt 406. In one or more instances, the input-output page sequence pairs include input session tokens and output session tokens, input page descriptors and output page descriptors for a navigation session(s), and/or input page sequence data and output page sequence data.

As further shown in FIG. 4, in some instances, the digital page sequence machine learning system 106 determines the similarity measures between the page sequence data of the user and training data generated from user navigation data of one or more additional users utilizing an embedding space. For instance, the digital page sequence machine learning system 106 utilizes a similarity measure between the page sequence data of the user and the page sequence data from the input-output sequence pairs. For example, the digital page sequence machine learning system 106 utilizes cosine similarities (or other similarity measures, such as Euclidean) between word embeddings generated from the page sequence data to identify similar input-output page. For instance, the digital page sequence machine learning system 106 utilizes word embeddings generated from machine learning models, such as, but not limited to bidirectional encoder representations (BERT), Sentence-BERT, other text transformer models, and/or other word processing machine learning models.

To illustrate, in one or more implementations, the digital page sequence machine learning system 106 generates (or identifies) embeddings of the training input sessions from a training dataset of input-output page sequence pairs and embeddings of the page sequence data of the user. Moreover, in one or more instances, the digital page sequence machine learning system 106 generates similarity measures (e.g., cosine similarity, Euclidean similarity) to select one or more input-output page sequence pairs by comparing similarity measures between the embeddings of the training input sessions and one or more embeddings of the input session (from the user). In some instances, the digital page sequence machine learning system 106 selects the one or more training input-output page sequence pairs that meet a threshold similarity measure. Indeed, in one or more implementations, the digital page sequence machine learning system 106 selects various numbers of training input-output page sequence pairs that meet the threshold similarity measure with the one or more embeddings of the input session (from the user).

In some instances, the digital page sequence machine learning system 106 enables flexible modification of an input prompt by an administrator device. For example, an administrator, via an administrator device, configuring an implementation of the digital page sequence machine learning system 106 is able to modify the input prompt templates (as described above) utilized by the digital page sequence machine learning system 106. For instance, the digital page sequence machine learning system 106 enables modification of the input prompt to modify an output of the large language model (e.g., to predict a particular target outcome, such as a predicted add-to-cart action, a predicted checkout action, an electronic communication action by the user, viewing of a video stream or image by the user, sharing content on a social media post, liking a social media post, following or subscribing to a social media account). In some instances, the digital page sequence machine learning system 106 enables modification of the input prompt to modify a number of sample (training) input-output page sequence pairs utilized in the input prompt, a number of sample user navigation session tokens for a user utilized in the input prompt, and/or an output format of the large language model.

As also mentioned above, the digital page sequence machine learning system 106 utilizes the input prompt with a large language model to generate a predicted page sequence. For instance, the digital page sequence machine learning system 106 provides the input prompt to the large language model to cause the large language model to (autoregressively) generate a predicted page sequence that predicts a likely user navigation session journey of the user in an additional (and/or subsequent) user navigation session. Indeed, in some embodiments, the digital page sequence machine learning system 106 utilizes a transformer-based large language model that generates output user navigation session tokens based on previously generated user navigation session tokens (to progressively build a sequence of tokens).

As shown in FIG. 4, the digital page sequence machine learning system 106 utilizes the large language model 408 with the input prompt 406 to generate a predicted page sequence 410. In one or more instances, the digital page sequence machine learning system 106 receives output user navigation session tokens from the large language model and utilizes the output user navigation session tokens to generate a predicted page sequence (e.g., through page descriptors). For instance, as shown in FIG. 4, the digital page sequence machine learning system 106 generates the predicted page sequence 410 with a predicted sequence of page descriptors (e.g., Page 1, Page 2, . . . , Page N). Indeed, in one or more instances, the large language model 408 generates an output predicted page sequence as, but not limited to, a sequence of user navigation session tokens, a sequence of page descriptors, and/or a sequence of page data (e.g., page URLs).

In addition, as shown in FIG. 4, the digital page sequence machine learning system 106, in some cases, utilizes the large language model 408 to generate a predicted source of arrival for the predicted page sequence 410. In particular, in one or more embodiments, the digital page sequence machine learning system 106 utilizes the large language model to predict a source of arrival token (or descriptor) associated with the particular predicted page sequence (e.g., to predict a starting source of the additional navigation session by the user). As an example, the digital page sequence machine learning system 106 utilizes the large language model to predict a source of arrival of search engine to indicate that the user is likely to navigate from a search engine to initiate the predicted page sequence. Indeed, in one or more implementations, the digital page sequence machine learning system 106 utilizes the large language model to predict various source of arrivals, such as, but not limited to, search engines, direct links, referral links, and/or banner interaction.

Moreover, in one or more embodiments (as shown in FIG. 4), the digital page sequence machine learning system 106 utilizes the large language model 408 to generate a predicted target outcome for the predicted page sequence 410. For example, the digital page sequence machine learning system 106 utilizes the large language model to predict a target outcome token (or descriptor) associated with the particular predicted page sequence. As an example, the digital page sequence machine learning system 106 utilizes the large language model to predict a target outcome that is likely from the predicted page sequence. For example, a target outcome includes, but is not limited to, an add-to-cart action, a checkout (or conversion) action, an exit action, and/or a bookmark action.

Although one or more embodiments illustrate the digital page sequence machine learning system 106 generating a single predicted page sequence from user page sequence data of a user, in one or more instances, the digital page sequence machine learning system 106 utilizes the large language model with input prompts generated for particular user navigation session tokens created from interactions between one or more users on one or more websites and/or digital applications (for various navigation sessions) to generate predicted page sequences for individual users and/or an aggregate of users.

In one or more instances, the digital page sequence machine learning system 106 trains a large language model to generate predicted page sequences. For instance, FIG. 5 illustrates the digital page sequence machine learning system 106 training a large language model to generate predicted page sequences. In particular, FIG. 5 illustrates the digital page sequence machine learning system 106 training a large language model to generate predicted page sequences utilizing training input and output session tokens.

As shown in FIG. 5, the digital page sequence machine learning system 106 identifies training input session tokens 504 from the training data 502 (of training input-output page sequence pairs). Moreover, as shown in FIG. 5, the digital page sequence machine learning system 106 utilizes the training input session tokens 504 with a large language model 506 to generate predicted output session tokens 508. In some cases, the digital page sequence machine learning system 106 generates an input prompt for the training input session tokens 504 (in accordance with one or more implementations herein) and utilizes the input prompt with the large language model 506 to generate the predicted output session tokens 508.

Furthermore, as shown in FIG. 5, the digital page sequence machine learning system 106 determines a measure of loss 512 for the predicted output session tokens 508. In particular, as shown in FIG. 5, the digital page sequence machine learning system 106 compares the predicted output session tokens 508 to ground truth output session tokens 510 corresponding to the training input session tokens 504 (from the training data 502) to generate the measure of loss 512. Indeed, in one or more instances, the digital page sequence machine learning system 106 utilizes the measure of loss 512 to modify parameters of the large language model 506. In one or more implementations, the digital page sequence machine learning system 106 utilizes measures of losses between predicted outputs and ground truth outputs iteratively to learn (or modify) parameters of the large language model 506 to accurately generate predicted page sequences (e.g., by reducing or minimizing the measure of loss 512).

As mentioned above, the digital page sequence machine learning system 106 utilizes a measure of loss to modify a large language model. In one or more instances, the digital page sequence machine learning system 106 utilizes a measure of loss between a ground truth sequence of session tokens and a probability distribution generated by the large language model for a set of session tokens (e.g., in a vocabulary of the large language model based on the training data 502). For instance, the digital page sequence machine learning system 106, considering sequences of sessions (where each session is a sequence of pages), encodes a user target text (sequence of pages in an additional or next session) as a sequence of input tokens with IDs: [symbol] =[T₁, T₂, T₃, . . . , Tₘ] in which m is the maximum sequence length (e.g., ground truth output session tokens).

In some cases, the digital page sequence machine learning system 106 utilizes a grouping of tokens to represent a page in a sequence of pages. For example, in one or more implementations, the digital page sequence machine learning system 106 represents an r^{th} page in the n^{th} user (sample) as P_{n,r} and represents a number of tokens encoding page P_{n,r} as t_{n,r} (where r≥1 and t_{n,0}=0). In addition, in one or more instances, the digital page sequence machine learning system 106 represents sub-sequences of tokens representing a page as P_{n,r}:[T₍ₜ_{_{n,r-1}}₎₊₁ . . . , T₍ₜ_{_{n,r-1}}₎₊₍ₜ_{_{n,r}}₎], where (t^{n,r-1})+(t^{n,r})≥m.

In one or more instances, the digital page sequence machine learning system 106 utilizes a large language model to generate a sequence of session tokens in the form of probability distributions. Indeed, in one or more instances, the digital page sequence machine learning system 106 represents the probability distributions of the predicted sequence of session tokens as [symbol] =[G₁, G₂, G₃, . . . , Gₘ], where each G_{i∈(1, 2, . . . , m)} is a probability distribution over the set of session tokens in a vocabulary of the large language model (e.g., based on the training data 502). In one or more implementations, to generate a measure of loss, the digital page sequence machine learning system 106 computes the sum of negative log-likelihoods (NLL) between ground truth output session tokens (for the training input tokens) and generated predicted session tokens at the corresponding positions. In particular, in one or more instances, the digital page sequence machine learning system 106 computes a measure of loss L between a one-hot encoded Tᵢ (e.g., the ground truth output session tokens) and a generated probability distribution Gᵢ (e.g., the predicted output session tokens) in accordance with the following function:

$${L}_{default} = - {\sum }_{i = 1}^{m} {T}_{i} log {G}_{i} \qquad ( 3 )$$

In one or more instances, the digital page sequence machine learning system 106 utilizes a page order agnostic loss as the measure of loss (e.g., a page order agnostic loss 514 as shown in FIG. 5). In particular, in one or more implementations, the digital page sequence machine learning system 106 utilizes a predicted page of sequence regardless of the sequence in which the pages are predicted to be visited within a session (e.g., to emphasize that a user is predicted to likely visit a set of pages). Indeed, in one or more instances, the digital page sequence machine learning system 106 generates a page order agnostic measure of loss that uses a set matching objective for training the large language model. For example, given a sub-sequence of session tokens that represent a page in a true label (e.g., tokens at sub-word levels), the digital page sequence machine learning system 106 identifies a degree of match with one or more neighboring-sub-sequence of same length, among the sequences of tokens in the predicted page sequence (e.g., predicted output session tokens).

In particular, in one or more instances, the digital page sequence machine learning system 106 computes a page order agnostic loss that matches predicted pages in a page sequence (e.g., output session tokens for predicted pages) regardless of order in the predicted page sequence and the ground truth target page sequence (e.g., the ground truth output session tokens) to obtain a non-zero value of loss. Indeed, in one or more implementations, the digital page sequence machine learning system 106 generates a page order agnostic loss with an objective to reduce or minimize a loss whenever a page from a target session (e.g., the ground truth output session tokens) is present in the predicted page sequence (e.g., the predicted output session tokens) irrespective of its position.

To generate the page order agnostic loss (as shown in FIG. 5), in one or more embodiments, the digital page sequence machine learning system 106 utilizes a matrix to represent the predicted output session token probability distribution G; and ground truth output session tokens Tᵢ. Indeed, in one or more implementations, the digital page sequence machine learning system 106 utilizes a rolling window, in the matrix, to identify, at each ground truth token(s) from the ground truth output session tokens Tᵢ, negative log-likelihood (NLL) score (e.g., a sum of diagonal NLL values) between the ground truth token(s) from the ground truth output session tokens Tᵢ and the predicted output session tokens in the predicted output session token probability distribution Gᵢ. Furthermore, in one or more instances, the digital page sequence machine learning system 106 selects, for each page in the page sequence, a minimum sum of diagonal NLL along the rolling windows to find closely matching predicted output session tokens from the predicted output session token probability distribution Gᵢ to the ground truth output session tokens Tᵢ (as the page order agnostic loss 514).

For instance, the digital page sequence machine learning system 106 utilizes a matrix (of size m×m) with row indices i representing [symbol] (e.g., the ground truth output session tokens) and column indices j representing [symbol] (e.g., the predicted sequence of session tokens). Furthermore, in one or more cases, the digital page sequence machine learning system 106 utilizes the value at position i,j as the negative log-likelihood (NLL) between the one-hot encoded Tᵢ (e.g., the ground truth output session tokens) and a generated probability distribution Gⱼ (e.g., the predicted output session tokens) (e.g., NLL (Tᵢ, Gⱼ). Moreover, for each page P_{n,r}: [T₍ₜ_{_{n,r-1}}₎₊₁, . . . , T₍ₜ_{_{n,r-1}}₎₊₍ₜ_{_{n,r}}₎] (in the page sequence), the digital page sequence machine learning system 106, in one or more instances, utilizes a rolling window matrix of size t_{n,r}×t_{n,r}.

Moreover, in one or more cases, the digital page sequence machine learning system 106, by fixing the rows indexed by tokens in P_{n,r}, shifts the rolling window by one position along the columns Gⱼ. Furthermore, in one or more embodiments, the digital page sequence machine learning system 106 generates a sum of values on the rolling window diagonal. In addition, in one or more instances, the digital page sequence machine learning system 106 increments the index j from 1 to m−t_{n,r}+1. Indeed, in one or more cases, the digital page sequence machine learning system 106 generates a sum of diagonal j, for a given page P_{n,r}, as the sum of NLL values computed between the corresponding tokens in [T₍ₜ_{_{n,r-1}}₎₊₁, . . . , T₍ₜ_{_{n,r-1}}₎₊₍ₜ_{_{n,r}}₎] and [Gⱼ, . . . , Gⱼ₊ₜ_{_{n,r}}₋₁].

Furthermore, in one or more implementations, the digital page sequence machine learning system 106 selects, for each page P_{n,r}, a minimum sum of diagonal among the rolling windows. For example, the digital page sequence machine learning system 106 selects a minimum sum of diagonal such that if the j^{th} rolling window has the minimum sum-of-diagonal, it most closely matches the [G_{j:j+t}_{_{n,r}}₋₁] sub-sequence with the target page sub-sequence (e.g., the ground truth page sub-sequence from the ground truth output session tokens). In one or more implementations, the digital page sequence machine learning system 106 computes the mean of minimum sum of diagonals (as the page order agnostic loss) by repeating the above-mentioned computation for each page in a sample (e.g., in the ground truth output session tokens). For example, the digital page sequence machine learning system 106 generates a page order agnostic loss Lpog in accordance with the following function:

$${L}_{poa} = \frac{1}{N} {{\sum }^{N}}_{n = 1} \frac{1}{{p}_{n}} {{\sum }^{{p}_{n}}}_{r = 1} {min}_{j ∈ [ 1 , m - ( {t}_{n , r} ) + 1 ]} ( {\sum }_{k = 1}^{k = {t}_{n , r}} NLL ( {T}_{{t}_{n , r - 1}} , {G}_{j + ( k - 1 )} ) ) \qquad ( 4 )$$

In the above mentioned function, the digital page sequence machine learning system 106, in one or more implementations, utilizes a number of users (samples) as N (in the training batch) and pₙ as the number of pages for the n^{th} user (sample).

Although one or more embodiments herein describe a particular measure of loss for the large language model, the digital page sequence machine learning system 106, in some instances, utilizes various (or various combinations of) measures of losses, such as, but not limited to, a cross-entropy measure of loss and/or mean-squared error loss. Furthermore, in one or more cases, the digital page sequence machine learning system 106 utilizes a combination of one or more measures of loss (e.g., one or more losses described herein). For example, in some implementations, the digital page sequence machine learning system 106 utilizes a combination of a page order agnostic loss and a cross-entropy loss as the measure of loss for the large language model.

Furthermore, in one or more implementations, the digital page sequence machine learning system 106 utilizes a predicted page sequence to select digital content for a client device corresponding to the user of the user navigation data. For instance, FIG. 6 illustrates the digital page sequence machine learning system 106 utilizing a predicted page sequence to select (or generate) digital content for a client device. Indeed, FIG. 6 illustrates the digital page sequence machine learning system 106 utilizing a predicted page sequence to select (or generate) digital content to execute or implement a wide variety of digital user navigation recommendation and/or digital marketing tasks in relation to the user of the client device.

For instance, as shown in act 604 of FIG. 6, the digital page sequence machine learning system 106 utilizes a predicted page sequence 602 (e.g., having various combinations of the predicted page sequence, predicted arrival of source, and/or predicted target outcome) to select digital content for a client device. Indeed, as shown in FIG. 6, the digital content includes electronic communications, selectable user interface elements, digital reports, and/or a segment of users. As illustrated in FIG. 6, the digital page sequence machine learning system 106 provides (or transmits) the selected digital content to a client device(s) 606 of the user corresponding to the predicted page sequence 602.

For example, in one or more implementations, the digital page sequence machine learning system 106 selects (or generates) electronic communications based on the predicted page sequence. For instance, upon determining that a target page (e.g., a specific product page or conversion page) is predicted to be visited by a user in a navigation session, the digital page sequence machine learning system 106 (and/or the data analytics system 104) generates an electronic communication (e.g., email, message, popup) to the client device of the user to positively reinforce a potential conversion toward the target page. For example, the digital page sequence machine learning system 106 (and/or the data analytics system 104) transmits an electronic communication to advertise the target page and/or incentivize the target page and/or initiates an electronic communication with a service representative (e.g., a chat bot or service agent) to assist a user to the target page.

In some instances, the digital page sequence machine learning system 106 utilizes the predicted page sequence to select (or generate) selectable user interface elements. For instance, the digital page sequence machine learning system 106 utilizes the predicted page sequence to select a particular user interface element that enables quicker (or direct) navigation to a target page (or target outcome action) within the predicted page sequence. In some cases, the digital page sequence machine learning system 106 (and/or the data analytics system 104) provides, for display within a graphical user interface of the client device, the selected user interface element to enable access to the target page (or target outcome action) within the predicted page sequence. For instance, the digital page sequence machine learning system 106 (and/or the data analytics system 104) displays the selected user interface element within an electronic communication, within a website page, and/or within a graphical user interface of a digital application.

In one or more implementations, the digital page sequence machine learning system 106 (and/or the data analytics system 104) utilizes the predicted page sequence to generate digital reports. For instance, the digital page sequence machine learning system 106 generates digital reports to present statistics of user navigation sessions (of one or more users) on a particular website and/or digital application and/or predicted user navigation sessions from the predicted page sequences. As an example, the digital page sequence machine learning system 106 generates digital reports for, but not limited to, conversion statistics, target outcome or target page visit statistics (e.g., a probable number of users visiting over a time period), and/or user segmentations determined from predicted page sequences (as described below). Indeed, in one or more instances, the digital page sequence machine learning system 106 generate digital reports for specific users and/or aggregated reports for multiple users.

In some cases, the digital page sequence machine learning system 106 (and/or the data analytics system 104) utilizes the predicted page sequence to predict an arrival source related to the predicted page sequence (e.g., the predicted navigation session). For example, the digital page sequence machine learning system 106 (and/or the data analytics system 104) determines a source of arrival (e.g., via a particular search engine, a referral link, an advertisement banner) for the predicted user navigation session (from the predicted page sequence). Indeed, in one or more instances, the digital page sequence machine learning system 106 (and/or the data analytics system 104) utilizes the predicted source of arrival to generate a digital report for statistics on sources of arrivals and/or to dynamically adjust or configure marketing campaigns (e.g., adjust or configure resources utilized in particular marketing campaigns, such as, but not limited to, search engine optimization bids, advertisement banner bids, frequency of referral and/or other electronic communication transmittals).

In some implementations, the digital page sequence machine learning system 106 (and/or the data analytics system 104) utilizes the predicted page sequence to predict a target outcome related to the predicted page sequence (e.g., the predicted navigation session). For instance, the digital page sequence machine learning system 106 (and/or the data analytics system 104) determines a target outcome (e.g., a predicted add-to-cart action, a predicted conversion action, a predicted webpage exit, a predicted electronic communication initiation by the user (customer service communication)) for the predicted user navigation session (from the predicted page sequence). Indeed, in one or more instances, the digital page sequence machine learning system 106 (and/or the data analytics system 104) utilizes the predicted target outcome to initiate a particular action to facilitate and/or increase the likelihood of the target outcome. For instance, the digital page sequence machine learning system 106 (and/or the data analytics system 104) selects (or transmits) electronic communications and/or displays selectable user interface elements corresponding to the predicted target outcome (e.g., a selectable interface element to navigate to checkout, a selectable interface element to initiate an electronic communication with customer service, an electronic communication reminding a user of an add-to-cart action). Furthermore, in some cases, the digital page sequence machine learning system 106 also dynamically adjusts or configures marketing campaigns (e.g., adjust or configure resources utilized in particular marketing campaigns, such as, but not limited to, search engine optimization bids, advertisement banner bids, frequency of referral and/or other electronic communication transmittals) based on the predicted target outcomes for the user.

Moreover, as illustrated in FIG. 6, the digital page sequence machine learning system 106 also utilizes the predicted page sequence to generate user segments. In particular, in one or more instances, the digital page sequence machine learning system 106 utilizes predicted page sequences of the user and additional users to segment users into groups (e.g., groups of similar navigation sessions). For instance, FIG. 7 illustrates the digital page sequence machine learning system 106 utilizing the predicted page sequence to generate user segments.

As shown in FIG. 7, the digital page sequence machine learning system 106 identifies a plurality of page sequences from users 704. In some implementations, the digital page sequence machine learning system 106 utilizes existing page sequences from users as the plurality of page sequences from users 704 (in accordance with one or more implementations herein). In some cases, as shown in FIG. 7, the digital page sequence machine learning system 106 generates predicted page sequences for the users as the plurality of page sequences from users 704. For example, as shown in FIG. 7, the digital page sequence machine learning system 106 identifies user navigation data 710 for the plurality of users 706 (from the client device(s) 708) in accordance with one or more implementations herein. Moreover, as shown in FIG. 7, the digital page sequence machine learning system 106 utilizes the user navigation data 710 (e.g., user navigation session tokens generated from the user navigation data 710) with a large language model 712 to generate the plurality of page sequences 704 (in accordance with one or more implementations herein).

Furthermore, as shown in FIG. 7, the digital page sequence machine learning system 106 utilizes similarity measures 714 between the predicted page sequence 702 (of a user) and the plurality of page sequences 704 to generate a user segment(s) 716. Indeed, in one or more cases, the digital page sequence machine learning system 106 utilizes similarity measures to identify users corresponding to predicted page sequences that meet a similarity measure threshold (as the user segment(s) 716). In some instances, as shown in FIG. 7, the digital page sequence machine learning system 106 generates embeddings for the predicted page sequence 702 and the plurality of page sequences 704 within an embedding space 715 to determine similarity measures 714.

For example, in one or more instances, digital page sequence machine learning system 106 converts (by utilizing embedding machine learning models) the predicted page sequences of the users and additional users into embeddings for an embedding space (e.g., Sentence BERT embeddings, BERT embeddings) to capture semantic similarity between the predicted page sequence embeddings. For instance, the digital page sequence machine learning system 106 utilizes embeddings generated from machine learning models, such as, but not limited to bidirectional encoder representations (BERT), Sentence-BERT, other text transformer models, and/or other word processing machine learning models.

Moreover, in one or more instances, the digital page sequence machine learning system 106 utilizes a clustering algorithm to identify similar sessions among the predicted page sequence embeddings utilizing similarity measures and a similarity measure threshold. For example, the digital page sequence machine learning system 106 identifies predicted page sequence embeddings with similarity measures between the embeddings meeting the similarity measure threshold as similar (and belonging to the same user segment group). In one or more implementations, the digital page sequence machine learning system 106 utilizes a variety of similarity measures to compare the users (via the predicted page sequences). For instance, the digital page sequence machine learning system 106 utilizes a variety of similarity measures, such as, but not limited to, cosine similarities, Euclidean distances, and/or Manhattan distances. In one or more implementations, the digital page sequence machine learning system 106 utilizes a variety of clustering algorithms, such as, but not limited to, k-means clustering, hierarchical clustering, fast clustering, and/or topic modeling.

In some cases, the digital page sequence machine learning system 106 also filters user segment groups based on group (or community size). For instance, the digital page sequence machine learning system 106 excludes groupings of users that fail to meet a minimum group size threshold. In some cases, the digital page sequence machine learning system 106 utilizes groupings of users that meet a group size threshold.

In some cases, the digital page sequence machine learning system 106 also utilizes segmentation criteria to generate user segments. For example, the digital page sequence machine learning system 106 utilizes requested user navigation behaviors to identify a grouping of users that correspond to a page sequence similar to the requested user navigation behavior. Indeed, in one or more instances, the digital page sequence machine learning system 106 generates an embedding for the requested user navigation behavior (as a page sequence) and identifies users with predicted page sequences that match the user navigation behavior (e.g., the embedding for the requested user navigation behavior).

In some instances, the digital page sequence machine learning system 106 enables an administrator device to configure the similarity measure threshold, the minimum group size threshold, and/or the group size threshold.

Furthermore, in one or more instances, the digital page sequence machine learning system 106 outputs one or more user segments from the similarity measures for the predicted page sequences. In some cases, the digital page sequence machine learning system 106 further organizes the identified user segments by group size (e.g., descending or ascending). In some implementations, the digital page sequence machine learning system 106 identifies a user segment group (or community) central point (e.g., by displaying an indicator and/or listing the central point user first in a list of users). In some cases, the digital page sequence machine learning model system 106 identifies a page central point for a segment of users (e.g., a central point page visit similar to a segment of users).

In one or more instances, the digital page sequence machine learning system 106 selects (or generates) digital content for a user based on the user segments. For instance, the digital page sequence machine learning system 106 utilizes the user segment to select or transmit electronic communications and/or selectable user interface elements to client devices of the users in the user segments (in accordance with one or more implementations herein). Furthermore, in one or more implementations, the digital page sequence machine learning system 106 generates or displays digital reports utilizing the user segments statistics and/or generates target outcomes for the user segments in accordance with one or more implementations herein. For example, the digital page sequence machine learning model system 106 utilizes segments of users to identify users that are likely to visit a particular page (e.g., a product page) or perform a target outcome (e.g., an add-to-cart action). Additionally, in one or more cases, the digital page sequence machine learning system 106 utilizes the user segments to select or generate content recommendations (e.g., websites, e-commerce products, video streams, subscriptions, social media) based on the user segments (e.g., using similarities in the navigation session behaviors).

Furthermore, experimenters utilized an implementation of the digital page sequence machine learning system to generate predicted page sequences for users in comparison to baselines. For instance, the experimenters utilized test data for evaluation (that does not appear in training data for an implementation of a digital page sequence machine learning system). Indeed, the experimenters evaluated outputs against the test data session's targets using hit rates which were defined using two metrics: hit metric 1 defined as: 1, if at least one page is correctly predicted and 0 otherwise; and hit metric 2 defined as: the ratio of correctly predicted pages to the total number of predicted pages to indicate the proportion of predicted pages that are correct.

In addition, the experimenters utilized, as a baseline, a long short-term memory (LSTM) based neural network to predict next sessions as a text generation task trained on user navigation data with a tokenized format to represent the page sequences. Indeed, to train the baseline LSTM model, input-output pairs of tokenized page sequences were input into the model, a loss was calculated between predicted and actual next tokens, an Adam optimizer was employed to update model parameters to minimize the loss, and training was conducted over multiple epochs with batch processing.

To evaluate the baseline and one or more implementations of the digital page sequence machine learning system (e.g., a large language model (base and chat version) with zero shot input prompts and a large language model with few shot input prompts), the experimenters utilized held-out test data (not utilized in tuning or training) in a prediction task that entails generating a set of pages to be visited by a user in a next session, given the context of pages in sessions that the user already traversed. An aggregate level of hit metrics (as described above) were calculated using comparisons of generated sets of pages with actual sets of pages in the test data. Moreover, for the test data, the experimenters utilized Adobe Data (a dataset from Adobe.com) and Google Data (a publicly available Google analytics dataset).

As shown in Table 1 and Table 2 below, various implementations of the digital page sequence machine learning system outperformed the baseline LSTM model.

TABLE 1

Adobe Data

| | Hit Metric 1 | Hit Metric 2 |
|---|---|---|
| Baseline LSTM | 0.1193 | 0.1132 |
| LLM Base: Zero Shot | 0.1670 | 0.1475 |
| LLM Base: Few Shot | 0.2056 | 0.1796 |
| LLM Chat: Zero Shot | 0.0921 | 0.0709 |
| LLM Chat: Few Shot | 0.1820 | 0.1569 |

TABLE 2

Google Data

| | Hit Metric 1 | Hit Metric 2 |
|---|---|---|
| Baseline LSTM | 0.1445 | 0.0898 |
| LLM Base: Zero Shot | 0.3855 | 0.2468 |
| LLM Base: Few Shot | 0.3465 | 0.2109 |
| LLM Chat: Zero Shot | 0.2279 | 0.1823 |
| LLM Chat: Few Shot | 0.7648 | 0.2671 |

Additionally, the experimenters also evaluated the accuracy of source of arrival predictions using an implementation of the digital page sequence machine learning system. In particular, the experimenters configured the implementation of the digital page sequence machine learning system to predict a source of arrival token for a page sequence. As shown in Table 3 below, the implementation of the digital page sequence machine learning system was able to favorably predict a source of arrival in the Adobe data and the Google Data.

TABLE 3

LLM Chat: Few Shot

| | Hit Metric 1 | Hit Metric 2 |
|---|---|---|
| Adobe Data | 0.5824 | 0.3269 |
| Google Data | 0.9282 | 0.3567 |

Additionally, the experimenters evaluated the ability of the implementation of the digital page sequence machine learning system to predict a target outcome (e.g., add-to-cart action) in the Google dataset. Indeed, an implementation of the digital page sequence machine learning system (LLM Chat: Few Shot) predicted an add-to-cart action with an F1-score of 0.44, with a balanced precision and recall of 0.42 and 0.46, respectively.

Moreover, the experimenters also evaluated the effect of utilizing a page order agnostic loss (as described above) in training an implementation of the digital page sequence machine learning system. In particular, the experimenters compared, for the Google dataset, of training an implementation of the digital page sequence machine learning system with a baseline (default) loss (e.g., as described in function (3)) and training an implementation of the digital page sequence machine learning system with a combination of the baseline loss and a page order agnostic loss (e.g., as described in function (4)). Indeed, as shown in Table 4 below, the combination of the baseline loss and a page order agnostic loss outperforms the baseline (default) loss.

TABLE 4

LLM: Google Data

| | | Hit Metric 1 | Hit Metric 2 |
|---|---|---|---|
| Loss 1 | Default_Loss | 0.684 | 0.331 |
| Loss 2 | Default + Page | 0.759 | 0.348 |
| | Order Agnostic | | |
| | Loss | | |

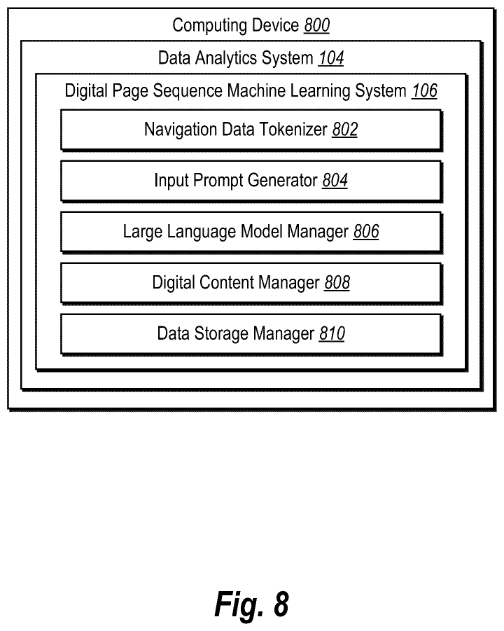

Turning now to FIG. 8, additional detail will be provided regarding components and capabilities of one or more embodiments of the digital page sequence machine learning system. In particular, FIG. 8 illustrates an example digital page sequence machine learning system 106 executed by a computing device 800 (e.g., the server device(s) 102, the client devices 110a-110n, and/or the administrator device 118). As shown by the embodiment of FIG. 8, the computing device 800 includes or hosts the data analytics system 104 and the digital page sequence machine learning system 106. Furthermore, as shown in FIG. 8, the data analytics system 104 includes a navigation data tokenizer 802, an input prompt generator 804, a large language model manager 806, a digital content manager 808, and data storage manager 810.

As just mentioned, and as illustrated in the embodiment of FIG. 8, the digital page sequence machine learning system 106 includes navigation data tokenizer 802. For example, the navigation data tokenizer 802 generates page descriptors from user navigation page sequence data (e.g., page URL visits) as described above (e.g., in relation to FIG. 3). Furthermore, in one or more cases, the navigation data tokenizer 802 generates user navigation session tokens from the page descriptors (e.g., arrival of source tokens, page tokens, beginning of session tokens, end of session tokens) as described above (e.g., in relation to FIG. 3). Moreover, in one or more instances, the navigation data tokenizer 802 also generates user navigation session token training data as described above (e.g., in relation to FIG. 3).

Moreover, as shown in FIG. 8, the digital page sequence machine learning system 106 includes input prompt generator 804. In some cases, the input prompt generator 804 generates an input prompt utilizing a request to generate a predicted page sequence and sample user navigation session tokens of a user (e.g., a zero-shot prompt) as described above (e.g., in relation to FIG. 4). Moreover, the input prompt generator 804 also generates an input prompt utilizing a request to generate a predicted page sequence, sample user navigation session tokens of a user, and sample training user navigation session tokens of additional users (e.g., a few-shot prompt) as described above (e.g., in relation to FIG. 4).

Furthermore, as shown in FIG. 8, the digital page sequence machine learning system 106 includes the large language model manager 806. In some embodiments, the large language model manager 806 utilizes an input prompt to generate a predicted page sequence for one or more users as described above (e.g., in relation to FIG. 5). Additionally, in some cases, the large language model manager 806 also trains a large language model utilizing a page order agnostic loss as described above (e.g., in relation to FIG. 5).

Moreover, as shown in FIG. 8, the digital page sequence machine learning system 106 includes the digital content manager 808. In some cases, the digital content manager 808 utilizes a predicted page sequence to select digital content for a client device of a user corresponding to the user navigation data as described above (e.g., in relation to FIG. 6). Furthermore, the digital content manager 808 also generates or identifies user segments utilizing a predicted page sequence as described above (e.g., in relation to FIG. 7).

As further shown in FIG. 8, the digital page sequence machine learning system 106 includes the data storage manager 810. In some embodiments, the data storage manager 810 maintains data to perform one or more functions of the digital page sequence machine learning system 106. For example, the data storage manager 810 includes large language models, large language model parameters, training user navigation data, user navigation session tokens and/or navigation session data, predicted page sequences, digital content, and/or user segmentation data.

Each of the components 802-810 of the computing device 800 (e.g., the computing device 800 implementing the digital page sequence machine learning system 106), as shown in FIG. 8, may be in communication with one another using any suitable technology. The components 802-810 of the computing device 800 can comprise software, hardware, or both. For example, the components 802-810 can comprise one or more instructions stored on a computer-readable storage medium and executable by processor of one or more computing devices. When executed by the one or more processors, the computer-executable instructions of the digital page sequence machine learning system 106 (e.g., via the computing device 800) can cause a client device and/or server device to perform the methods described herein. Alternatively, the components 802-810 and their corresponding elements can comprise hardware, such as a special purpose processing device to perform a certain function or group of functions. Additionally, the components 802-810 can comprise a combination of computer-executable instructions and hardware.

Furthermore, the components 802-810 of the digital page sequence machine learning system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 802-810 may be implemented as a stand-alone application, such as a desktop or mobile application. Furthermore, the components 802-810 may be implemented as one or more web-based applications hosted on a remote server. The components 802-810 may also be implemented in a suite of mobile device applications or “apps.” To illustrate, the components 802-810 may be implemented in an application, including but not limited to, ADOBE ANALYTICS CLOUD, ADOBE ANALYTICS, ADOBE AUDIENCE MANAGER, ADOBE CAMPAIGN, ADOBE EXPERIENCE MANAGER, and ADOBE TARGET. “ADOBE,” “ADOBE ANALYTICS CLOUD,” “ADOBE ANALYTICS,” “ADOBE AUDIENCE MANAGER,” “ADOBE CAMPAIGN,” “ADOBE EXPERIENCE MANAGER,” and “ADOBE TARGET” are either registered trademarks or trademarks of Adobe Inc. in the United States and/or other countries.

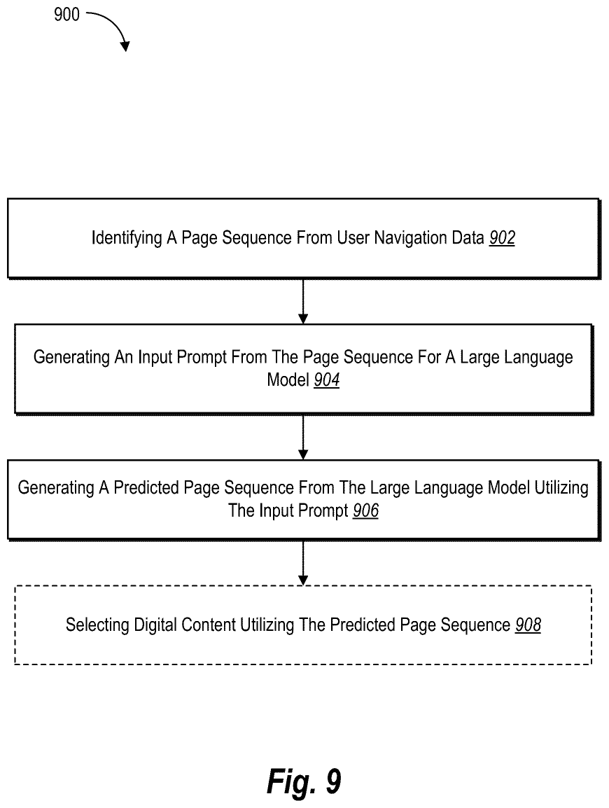

FIGS. 1-8, the corresponding text, and the examples provide a number of different methods, systems, devices, and non-transitory computer-readable media of the digital page sequence machine learning system 106. In addition to the foregoing, one or more embodiments can also be described in terms of flowcharts comprising acts for accomplishing a particular result, as shown in FIG. 9. The acts shown in FIG. 9 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 9. In some embodiments, a system can be configured to perform the acts of FIG. 9. Alternatively, the acts of FIG. 9 can be performed as part of a computer implemented method.

As mentioned above, FIG. 9 illustrates a flowchart of a series of acts 900 for utilizing digital page sequence data with large language models to generate digital page navigation predictions for users in accordance with one or more implementations. While FIG. 9 illustrates acts according to one embodiment, alternative embodiments may omit, add to, reorder, and/or modify any of the acts shown in FIG. 9.

For instance, FIG. 9 illustrates an example series of acts for utilizing digital page sequence data with large language models to generate digital page navigation predictions for users in accordance with one or more implementations. Indeed, as shown in FIG. 9, the series of acts 900 include an act 902 of identifying a page sequence from user navigation data, an act 904 of generating an input prompt from the page sequence for a large language model, and an act 906 of generating a predicted page sequence form the large language model utilizing the input prompt. In some cases, the series of acts 900 also includes an act 908 of selecting digital content utilizing the predicted page sequence.

In one or more instances, the series of acts 900 include generating, utilizing a tokenizer, a set of user navigation session tokens from page sequence descriptors identified from a user navigation session, generating, utilizing a prompt generation model, an input prompt for a large language model from the set of user navigation session tokens, and generating, utilizing the large language model with the input prompt, a predicted page sequence for an additional user navigation session.

In some implementations, the series of acts 900 include generating a set of user navigation session tokens by identifying a uniform resource locator (URL) page visits sequence for a user from user navigation data, converting the URL page visits sequence to a page descriptors sequence, and tokenizing the page descriptors sequence, and generating a predicted page sequence for an additional user navigation session by analyzing the set of user navigation session tokens utilizing a large language model.

Furthermore, in some cases, the series of acts 900 include generating, utilizing the prompt generation model, the input prompt by generating a first prompt portion of the set of user navigation session tokens as an input session and generating a second prompt portion of a request to generate the predicted page sequence based on the input session.

In addition, in some cases, the series of acts 900 include generating, utilizing the prompt generation model, the input prompt by generating a first prompt portion of one or more input-output page sequence pairs, generating a second prompt portion of the set of user navigation session tokens as an input session, and a third prompt portion of a request to generate the predicted page sequence based on the input session and the one or more input-output page sequence pairs.

Moreover, in one or more instances, the series of acts 900 include identifying embeddings of training input sessions from a training dataset of training input-output page sequence pairs and selecting the one or more input-output page sequence pairs by comparing similarity measures between the embeddings of the training input sessions and an embedding of the input session.

In addition, in one or more instances, the series of acts 900 include modifying parameters of the large language model utilizing a set of training input-output page sequence pairs and a page order agnostic measure of loss.

Moreover, in one or more instances, the series of acts 900 include generating the page descriptors sequence from a uniform resource locator (URL) page visits sequence for a user from user navigation data.

In addition, in some cases, the series of acts 900 include generating, utilizing the tokenizer, the set of user navigation session tokens by generating a source of arrival token representing an initiation platform for the user navigation session and generating one or more page tokens.

Furthermore, in some cases, the series of acts 900 include utilizing the predicted page sequence to select digital content for a client device of a user corresponding to the user navigation session, wherein the digital content comprises an electronic communication based on the predicted page sequence or a selectable option to navigate to a target outcome from the predicted page sequence.

Moreover, in one or more instances, the series of acts 900 include utilizing the predicted page sequence to predict a source of arrival for a client device of a user corresponding to the user navigation session.

Furthermore, in some cases, the series of acts 900 include generating, utilizing the large language model, a plurality of predicted page sequences for a plurality of users and determining a segment of users based on comparisons between the predicted page sequence for a user corresponding to the user navigation session and the plurality of predicted page sequences for the plurality of users.

Moreover, in one or more instances, the series of acts 900 include tokenizing the page descriptors sequence by generating a source of arrival token, a beginning of session token, one or more page tokens, and an end of session token.

In addition, in some cases, the series of acts 900 include utilizing the set of user navigation session tokens to generate an input prompt by generating a first prompt portion of the set of user navigation session tokens as an input session and generating a second prompt portion of a request to generate the predicted page sequence based on the input session. Furthermore, in some cases, the series of acts 900 include utilizing the set of user navigation session tokens to generate an input prompt by selecting one or more input-output page sequence pairs utilizing similarity measures between one or more input sessions of the one or more input-output page sequence pairs and the set of user navigation session tokens, generating a first prompt portion of the one or more input-output page sequence pairs, generating a second prompt portion of the set of user navigation session tokens as an input session, and generating a third prompt portion of a request to generate the predicted page sequence based on the input session and the one or more input-output page sequence pairs. Moreover, in one or more instances, the series of acts 900 include generating the predicted page sequence by utilizing the input prompt with the large language model.

Furthermore, in some cases, the series of acts 900 include training the large language model to predict user navigation session sequences by modifying parameters of the large language model utilizing a page order agnostic measure of loss.

In addition, in some cases, the series of acts 900 include utilizing the predicted page sequence to select digital content for a client device of the user.

In some cases, the series of acts 900 include identifying a uniform resource locator (URL) page visits sequence for a user from user navigation data of a user navigation session. Moreover, in some cases, the series of acts 900 include utilizing the predicted page sequence to select digital content for a client device of the user corresponding to the user navigation session.

Additionally, in some cases, the series of acts 900 include selecting the digital content by selecting an electronic communication to transmit to the client device based on the predicted page sequence.

In addition, in some cases, the series of acts 900 include selecting the digital content by determining a target outcome from the predicted page sequence and selecting, to display on a graphical user interface of the client device, a selectable option to navigate to the target outcome. Moreover, in some cases, the series of acts 900 include selecting the digital content by determining a segment of users based on comparisons between the predicted page sequence for the user and a plurality of predicted page sequences for a plurality of users generating utilizing the large language model and selecting the digital content based on the segment of users.

In addition (or in alternative) to the acts above, the digital page sequence machine learning system 106, in some cases, also performs a step for generating a predicted page sequence for an additional user navigation session of a user from the URL page visits sequence and a large language model. For instance, the acts and algorithms described above in relation to FIGS. 4 and 5 (e.g., the acts 402-412 and 502-514) comprise the corresponding acts and algorithms for performing a step for generating a predicted page sequence for an additional user navigation session of a user from the URL page visits sequence and a large language model.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium.

Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., the server device(s) 102, the client devices 110a-110n, and/or the administrator device 118). In one or more implementations, the computing device 1000 may be a mobile device (e.g., a mobile telephone, a smartphone, a PDA, a tablet, a laptop, a camera, a tracker, a watch, a wearable device, etc.). In some implementations, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other implementations. Furthermore, in certain implementations, the computing device 1000 includes fewer components than those shown in FIG. 10. Components of the computing device 1000 shown in FIG. 10 will now be described in additional detail.

In particular implementations, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, the storage device 1006 can include a non-transitory storage medium described above. The storage device 1006 may include a hard disk drive (“HDD”), flash memory, a Universal Serial Bus (“USB”) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (“NIC”) or network adapter for communicating with an Ethernet or other wire-based network or a wireless NIC (“WNIC”) or wireless adapter for communicating with a wireless network, such as a WI-FI. The computing device 1010 can further include a bus 1012. The bus 1012 can include hardware, software, or both that connects components of the computing device 1000 to each other.

In the foregoing specification, the invention has been described with reference to specific example implementations thereof. Various implementations and aspects of the invention(s) are described with reference to details discussed herein, and the accompanying drawings illustrate the various implementations. The description above and drawings are illustrative of the invention and are not to be construed as limiting the invention. Numerous specific details are described to provide a thorough understanding of various implementations of the present invention.

The present invention may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions that, when executed by at least one processor, cause the at least one processor to perform operations comprising:
generating, utilizing a tokenizer, a set of user navigation session tokens from page sequence descriptors identified from a user navigation session;
generating, utilizing a prompt generation model, an input prompt for a large language model from the set of user navigation session tokens; and
generating, utilizing the large language model with the input prompt, a predicted page sequence for an additional user navigation session.

2. The non-transitory computer-readable medium of claim 1, wherein the operations further comprise generating, utilizing the prompt generation model, the input prompt by generating a first prompt portion of the set of user navigation session tokens as an input session and generating a second prompt portion of a request to generate the predicted page sequence based on the input session.

3. The non-transitory computer-readable medium of claim 1, wherein the operations further comprise generating, utilizing the prompt generation model, the input prompt by generating a first prompt portion of one or more input-output page sequence pairs, generating a second prompt portion of the set of user navigation session tokens as an input session, and a third prompt portion of a request to generate the predicted page sequence based on the input session and the one or more input-output page sequence pairs.

4. The non-transitory computer-readable medium of claim 3, wherein the operations further comprise:
identifying embeddings of training input sessions from a training dataset of training input-output page sequence pairs; and
selecting the one or more input-output page sequence pairs by comparing similarity measures between the embeddings of the training input sessions and an embedding of the input session.

5. The non-transitory computer-readable medium of claim 1, wherein the operations further comprise modifying parameters of the large language model utilizing a set of training input-output page sequence pairs and a page order agnostic measure of loss.

6. The non-transitory computer-readable medium of claim 1, wherein the operations further comprise generating the page descriptors sequence from a uniform resource locator (URL) page visits sequence for a user from user navigation data.

7. The non-transitory computer-readable medium of claim 1, wherein the operations further comprise generating, utilizing the tokenizer, the set of user navigation session tokens by generating a source of arrival token representing an initiation platform for the user navigation session and generating one or more page tokens.

8. The non-transitory computer-readable medium of claim 1, wherein the operations further comprise utilizing the predicted page sequence to select digital content for a client device of a user corresponding to the user navigation session, wherein the digital content comprises an electronic communication based on the predicted page sequence or a selectable option to navigate to a target outcome from the predicted page sequence.

9. The non-transitory computer-readable medium of claim 1, wherein the operations further comprise utilizing the predicted page sequence to predict a source of arrival for a client device of a user corresponding to the user navigation session.

10. The non-transitory computer-readable medium of claim 1, wherein the operations further comprise:
generating, utilizing the large language model, a plurality of predicted page sequences for a plurality of users; and
determining a segment of users based on comparisons between the predicted page sequence for a user corresponding to the user navigation session and the plurality of predicted page sequences for the plurality of users.

11. A system comprising:
one or more memory devices; and
one or more processors configured to cause the system to:
generate a set of user navigation session tokens by:
identifying a uniform resource locator (URL) page visits sequence for a user from user navigation data;
converting the URL page visits sequence to a page descriptors sequence; and
tokenizing the page descriptors sequence; and
generate a predicted page sequence for an additional user navigation session by analyzing the set of user navigation session tokens utilizing a large language model.

12. The system of claim 11, wherein the one or more processors are configured to further cause the system to tokenize the page descriptors sequence by generating a source of arrival token, a beginning of session token, one or more page tokens, and an end of session token.

13. The system of claim 11, wherein the one or more processors are configured to further cause the system to:
utilize the set of user navigation session tokens to generate an input prompt by:
generating a first prompt portion of the set of user navigation session tokens as an input session; and
generating a second prompt portion of a request to generate the predicted page sequence based on the input session; and
generate the predicted page sequence by utilizing the input prompt with the large language model.

14. The system of claim 11, wherein the one or more processors are configured to further cause the system to:
utilize the set of user navigation session tokens to generate an input prompt by:
selecting one or more input-output page sequence pairs utilizing similarity measures between one or more input sessions of the one or more input-output page sequence pairs and the set of user navigation session tokens;
generating a first prompt portion of the one or more input-output page sequence pairs;
generating a second prompt portion of the set of user navigation session tokens as an input session; and
generating a third prompt portion of a request to generate the predicted page sequence based on the input session and the one or more input-output page sequence pairs; and
generate the predicted page sequence by utilizing the input prompt with the large language model.

15. The system of claim 11, wherein the one or more processors are configured to further cause the system to train the large language model to predict user navigation session sequences by modifying parameters of the large language model utilizing a page order agnostic measure of loss.

16. The system of claim 11, wherein the one or more processors are configured to further cause the system to utilize the predicted page sequence to select digital content for a client device of the user.

17. A computer-implemented method comprising:
identifying a uniform resource locator (URL) page visits sequence for a user from user navigation data of a user navigation session;
performing a step for generating a predicted page sequence for an additional user navigation session of the user from the URL page visits sequence and a large language model; and
utilizing the predicted page sequence to select digital content for a client device of the user corresponding to the user navigation session.

18. The computer-implemented method of claim 17, further comprising selecting the digital content by selecting an electronic communication to transmit to the client device based on the predicted page sequence.

19. The computer-implemented method of claim 17, further comprising selecting the digital content by:
determining a target outcome from the predicted page sequence; and
selecting, to display on a graphical user interface of the client device, a selectable option to navigate to the target outcome.

20. The computer-implemented method of claim 17, further comprising selecting the digital content by:
determining a segment of users based on comparisons between the predicted page sequence for the user and a plurality of predicted page sequences for a plurality of users generating utilizing the large language model; and
selecting the digital content based on the segment of users.
